(19) United States
(12) Patent Application Publication
(10) Pub. No.: US 2026/0322683 A1
(43) Pub. Date: Oct. 15, 2026

(54) OPTICAL INTERCONNECT MONITORING AND FAULT DETECTION IN DISTRIBUTED COMPUTING COMPONENTS

(71) Applicant: Citibank, N.A., New York, NY (US)

(72) Inventors: Raja BALASUBRAMANIAN, Skillman, NJ (US); Rene Wilfredo VILLATORO ESCALANTE, Irving, TX (US); Chike Gideon OKECHUKWU, Denton, TX (US); Terry John JENKINS, Irving, TX (US); Scott TAYLOR, Keller, TX (US); James Randolph MYERS, Clearwater Beach, FL (US)

(73) Assignee: Citibank, N.A., New York, NY (US)

(21) Appl. No.: 19/717,639

(22) Filed: Jun. 23, 2026

Related U.S. Application Data
(63) Continuation-in-part of application No. 18/615,364, filed on Mar. 25, 2024, now Pat. No. 12,683,856.
Application No. 18/615,364 is a continuation of application No. 18/376,051, filed on Oct. 3, 2023, now Pat. No. 11,943,096.

(51) Int. Cl. H04L 41/069; H04B 10/03; H04B 10/079; H04L 41/22

(52) U.S. Cl. CPC H04L 41/069; H04B 10/03; H04B 10/07955; H04L 41/22

(57) ABSTRACT

A system for monitoring optical computing components is disclosed. The system may include processors and non-transitory computer-readable media comprising instructions. The system may receive optical measurements from optical interconnects internal to a distributed computing system, where the optical interconnects couple distributed computing components each having an associated optical communication device enabling optical communication at a package level. The system may receive performance metrics of the distributed computing components comprising workload activity, synchronization behavior, or thermal conditions. The system may input the optical measurements and performance metrics into an artificial intelligence model trained to predict potential faults. The system may determine a fault domain comprising a chiplet interface, an optical engine, a laser source, a coupler, or a reconfigurable optical path. The system may generate a message comprising a repair recommendation, an alert, or an automated corrective action based on the fault domain.

### CROSS-REFERENCE TO RELATED APPLICATIONS

This application is a continuation-in-part of U.S. patent application Ser. No. 18/615,364, filed Mar. 25, 2024, which is a continuation of U.S. patent application Ser. No. 18/376,051, filed Oct. 3, 2023 (now U.S. Pat. No. 11,943,096 issued Mar. 26, 2024). The content of the foregoing application is incorporated herein in its entirety by reference.

### BACKGROUND

Distributed computing systems increasingly rely on optical interconnects to enable high-bandwidth communication between computing components such as processors, memories, accelerators, network interfaces, and switches. As data center architectures evolve, optical communication is moving closer to the compute and memory elements themselves, extending beyond traditional network transceivers and external fiber links to include in-rack optical links, board-level optical engines, co-packaged optics, optical chiplets, package-level couplers, and optical switching paths. This expansion of optical interconnects introduces new challenges for system reliability and fault management. Optical paths within distributed computing systems may experience degradation or failure due to various factors and/or conditions.

### SUMMARY

Detecting and localizing faults within these optical interconnects can be difficult, particularly when optical communication occurs at multiple levels of the system architecture and involves diverse component types. Existing monitoring approaches may focus on individual optical links or network-level metrics without providing visibility into the relationships between optical measurements and the operational context of the distributed computing components. As optical interconnects become more deeply integrated into computing architectures, there is a general interest in monitoring approaches that can collect and analyze optical telemetry in conjunction with component-level operational data to support fault detection and system maintenance.

Accordingly, a fault detection system may be used to monitor computing components within a distributed computing system and detect/identify faults or potential faults within the computing components. The fault detection system may receive optical measurements (e.g., optical telemetry) from a plurality of optical interconnects internal to a distributed computing system. The optical interconnects may couple distributed computing components of the distributed computing system. Furthermore, each distributed computing component may include an associated optical communication device that enables optical communication at a package level. The system may receive performance metrics of the distributed computing components comprising one or more of workload activity, synchronization behavior, or thermal conditions associated with the distributed computing components. The system may input the optical measurements from the plurality of optical interconnects and the performance metrics of the distributed computing components into an artificial intelligence model to detect potential faults within the distributed computing system. The artificial intelligence model may be one that has been trained to predict the potential faults based on received optical measurements and received performance metrics. The system may determine, based on one or more potential faults, a fault domain within the distributed computing system. The fault domain may be one or more of a chiplet interface, an optical engine, a laser source, a coupler, and/or a reconfigurable optical path. The system may generate, based on the fault domain, a message that includes one or more of a repair recommendation, an alert, and/or an automated corrective action.

In some implementations, the fault detection system may receive optical measurements from a plurality of optical interconnects internal to a distributed computing system. The plurality of optical interconnects may couple distributed computing components of the distributed computing system. Each distributed computing component may include an associated optical communication device that enables optical communication at a package level. For example, the system may collect optical power readings and signal quality data from fiber optic links connecting processors, memory units, and accelerators within a data center rack. Optical interconnects may include fiber optic cables, waveguides, optical engines, and/or photonic integrated circuits that carry data between computing elements.

The fault detection system may also collect operational data about how the computing components are functioning. The fault detection system may receive performance metrics of the distributed computing components including one or more of workload activity, synchronization behavior, or thermal conditions associated with the distributed computing components. For example, the system may gather data indicating processor/memory utilization levels, timing coordination between components, and/or temperature readings from sensors on each computing component.

The system may provide a way to use machine learning to identify problems in the computing environment. The system may input the optical measurements from the plurality of optical interconnects and the performance metrics of the distributed computing components into an artificial intelligence model to detect potential faults within the distributed computing system. The artificial intelligence model may have been trained to predict the potential faults based on received optical measurements and received performance metrics. For example, the system may feed the collected optical and performance data into a neural network that has learned patterns associated with component failures from historical data.

The fault detection system may then provide a mechanism to pinpoint where a problem is occurring within the computing architecture. In particular, the fault detection system may determine, based on one or more potential faults, a fault domain within the distributed computing system. The fault domain may include one or more of a chiplet interface, an optical engine, a laser source, a coupler, or a reconfigurable optical path. For example, when the artificial intelligence model detects anomalous patterns, the system may identify that the issue originates from a specific optical engine on a particular board. Furthermore, the fault detection system may provide a method of communicating the detected issues and take action. In some implementations, the system may generate, based on the fault domain, a message including a repair recommendation, an alert, or an automated corrective action. For example, the system may send a notification to maintenance personnel recommending replacement of a degraded laser source or automatically reroute data traffic to avoid a failing optical path.

According to other aspects of the present disclosure, the fault detection system may provide detailed optical telemetry collection capabilities. The optical measurements may include one or more of optical power measurements, per-lane measurements, per-wavelength measurements, temperature measurements, error statistics, laser health data, or optical path state data. For example, the system may monitor individual wavelength channels in a wavelength-division multiplexed optical link, track bit error rates across different lanes of a parallel optical interface, and record temperature readings from laser diodes within optical engines.

The fault detection system may establish relationships between optical measurements and the physical topology of the distributed computing system. In particular, the fault detection system may determine a plurality of optical paths associated with the distributed computing components. Each optical path may be associated with two or more distributed computing components. The system may generate path tags and component tags within the optical measurements to indicate which optical path each measurement corresponds to and which set of components communicate over each optical path. These tags may be added to the optical measurements prior to inputting the optical measurements into the artificial intelligence model, enabling the model to understand the structural context of each measurement.

The fault detection system may also correlate optical measurements with component-level operational data to enable more accurate fault detection. In particular, the fault detection system may identify, for each optical measurement, a corresponding associated optical path and determine the set of distributed computing system components associated with each optical path. Based on corresponding directions of communication, the system may determine a correlation between each optical measurement and one or more corresponding performance metrics. The fault detection system may then link the optical measurements with the corresponding performance metrics prior to inputting into the artificial intelligence model. The artificial intelligence model may further identify degradation patterns associated with specific workload types determined from a combination of the optical measurements and the performance metrics. The artificial intelligence model may be one that has been trained using historical optical measurements correlated with observed fault events, corresponding fault domains, and component-level operational performance metrics collected at corresponding optical interconnects of distributed computing systems.

According to other aspects of the present disclosure, the system may determine a plurality of optical paths associated with the distributed computing components. Each optical path of the plurality of optical paths may be associated with two or more distributed computing components. The system may generate a plurality of path tags within the optical measurements to indicate a corresponding optical path for each measurement of the optical measurements. The system may add the plurality of path tags to the optical measurements prior to inputting the optical measurements into the artificial intelligence model. In some implementations, the optical measurements may include one or more of optical power measurements, per-lane measurements, per-wavelength measurements, temperature measurements, error statistics, laser health data, or optical path state data. These measurements may provide detailed telemetry regarding the health and performance of the optical interconnects within the distributed computing system.

In some implementations, the system may determine, for the plurality of optical paths, a corresponding set of components that communicate over each optical path. The system may generate a plurality of component tags within the optical measurements to indicate the corresponding set of components for each optical path and add the component tags to the optical measurements prior to inputting the optical measurements into the artificial intelligence model. For example, when monitoring an optical path connecting a processor chiplet to a memory controller, the system may generate component tags identifying both the processor chiplet and the memory controller as endpoints of that optical path. These component tags may be embedded within each optical power measurement and error statistic collected from that path, allowing the artificial intelligence model to associate the optical telemetry with the specific computing components involved in the communication. Furthermore, the automated corrective action may include one or more of retuning photonic elements within the distributed computing system and rerouting traffic within the distributed computing system over a different path. These corrective actions may be performed automatically in response to detected or predicted faults.

In some implementations, the plurality of optical interconnects may include a unified monitored fabric spanning the distributed computing system. The unified monitored fabric may provide visibility into optical paths between the distributed computing components that would not be visible to network-level monitoring of links between separate network devices. The system may further identify, for each optical measurement, a corresponding associated optical path and determine the set of distributed computing system components associated with each optical path. Based on corresponding directions of communication, the system may determine a correlation between each optical measurement and one or more corresponding performance metrics. The system may then link the optical measurements with the corresponding performance metrics prior to inputting into the artificial intelligence model.

According to other aspects of the present disclosure, the artificial intelligence model may be trained using historical optical measurements correlated with observed fault events, corresponding fault domains, and component-level operational performance metrics collected at corresponding optical interconnects of distributed computing systems. The artificial intelligence model may identify degradation patterns associated with specific workload types determined from a combination of the optical measurements and the performance metrics. This may enable the system to detect faults that manifest only under certain operational conditions.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 shows an illustrative environment for detecting faults using optical interconnects within a distributed computing system, in accordance with one or more embodiments of this disclosure.

FIG. 2 illustrates a system for monitoring optical computing components within a distributed computing system, in accordance with one or more embodiments of this disclosure.

FIG. 3 illustrates a data structure for correlating optical measurements with components and performance metrics within a distributed computing system, in accordance with one or more embodiments of this disclosure.

FIG. 4 illustrates a data structure for organizing optical measurement data with associated tagging information for optical interconnect monitoring within a distributed computing system, in accordance with one or more embodiments of this disclosure.

FIG. 5 illustrates a message used for communicating fault information within a distributed computing system, in accordance with one or more embodiments of this disclosure.

FIG. 6 illustrates an exemplary computing system, in accordance with one or more embodiments of this disclosure.

FIG. 7 illustrates exemplary machine learning models, in accordance with one or more embodiments of this disclosure.

FIG. 8 is a block diagram of an example transformer that may be used for detecting faults using optical interconnects within a distributed computing system, in accordance with one or more embodiments of this disclosure.

FIG. 9 is a flowchart of operations for detecting faults using optical interconnects within a distributed computing system, in accordance with one or more embodiments of this disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein. Furthermore, in the following description, for the purposes of explanation, numerous specific details are set forth in order to provide a thorough understanding of the disclosed embodiments. It will be appreciated, however, by those having skill in the art, that the embodiments may be practiced without these specific details or with an equivalent arrangement.

Distributed computing systems may rely on optical interconnects to enable high-bandwidth communication between computing components such as processors, memories, accelerators, network interfaces, and switches. As data center architectures evolve, optical communication may move closer to compute and memory elements, extending beyond traditional network transceivers and external fiber links to include in-rack optical links, board-level optical engines, co-packaged optics, optical chiplets, package-level couplers, and optical switching paths. The expansion of optical interconnects may introduce challenges for system reliability and fault management.

Optical paths within distributed computing systems may experience degradation or failure due to various factors and conditions. Detecting and localizing faults within optical interconnects may be difficult, particularly when optical communication occurs at multiple levels of the system architecture and involves diverse component types. A fault detection system may address these challenges by monitoring computing components within a distributed computing system and detecting faults or potential faults within the computing components. The fault detection system may provide a way to collect optical telemetry from optical interconnects and correlate the optical telemetry with component-level operational data. The fault detection system may receive optical measurements from a plurality of optical interconnects internal to a distributed computing system. The plurality of optical interconnects may couple distributed computing components of the distributed computing system. Each distributed computing component may include an associated optical communication device that enables optical communication at a package level.

The fault detection system may also receive performance metrics of the distributed computing components. The performance metrics may include one or more of workload activity, synchronization behavior, or thermal conditions associated with the distributed computing components. The fault detection system may input the optical measurements from the plurality of optical interconnects and the performance metrics of the distributed computing components into an artificial intelligence model to detect potential faults within the distributed computing system. The artificial intelligence model may be one that has been trained to predict potential faults based on received optical measurements and received performance metrics.

Furthermore, the fault detection system may determine, based on one or more potential faults, a fault domain within the distributed computing system. The fault domain may include one or more of a chiplet interface, an optical engine, a laser source, a coupler, or a reconfigurable optical path. The fault detection system may generate, based on the fault domain, a message that includes one or more of a repair recommendation, an alert, or an automated corrective action. The automated corrective action may include rerouting traffic, lowering link rate, retuning photonic elements, or scheduling maintenance. In this manner, the fault detection system may support system reliability and maintenance by collecting telemetry from optical interconnects, correlating the telemetry with operational context, applying analytics to detect or predict faults, localizing the likely source of the fault, and generating appropriate responses.

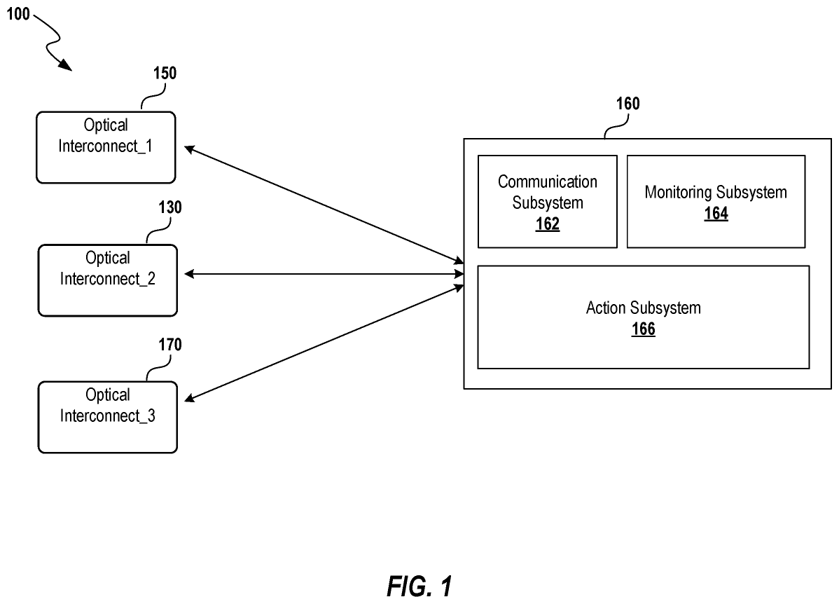

FIG. 1 illustrates an environment 100 for monitoring optical interconnects within a distributed computing system. Environment 100 may include a system for monitoring optical computing components. Environment 100 may include a distributed computing system configured as, for example, an AI cluster with hierarchical scale-up, scale-out, and scale-across optical interconnect models. In some implementations, the distributed computing system may include GPUs, CPUs, and accelerators that communicate across distances from millimeters to kilometers as if the GPUs, CPUs, and accelerators were parts of one large pooled compute complex. In some cases, the distributed computing system may include configurations where a first switch is moved away from a rack toward an end of a row, making copper impractical at 800G and higher speeds.

Environment 100 may include a fault detection system 160 that is communicatively coupled to a plurality of optical interconnects. Fault detection system 160 may include a communication subsystem 162, a monitoring subsystem 164, and an action subsystem 166. Communication subsystem 162 may facilitate data exchange between fault detection system 160 and the optical interconnects. Monitoring subsystem 164 may receive and process optical measurements and performance metrics from the optical interconnects to detect potential faults within the distributed computing system. Action subsystem 166 may generate responses based on detected faults, which may include repair recommendations, alerts, or automated corrective actions.

Fault detection system 160 may be communicatively coupled to an optical interconnect 1 150, an optical interconnect 2 130, and an optical interconnect 3 170. Optical interconnect 1 150, optical interconnect 2 130, and optical interconnect 3 170 may each be connected to fault detection system 160 via bidirectional communication paths. The bidirectional communication paths may enable fault detection system 160 to collect telemetry data from each optical interconnect and to send control signals or corrective actions back to the optical interconnects. Optical interconnect 1 150, optical interconnect 2 130, and optical interconnect 3 170 may couple distributed computing components within the distributed computing system. The optical interconnects may include in-rack optical links, board-level optical engines, co-packaged optics, optical chiplets, package-level couplers, or optical switching paths. Fault detection system 160 may treat these optical paths as part of a unified monitored fabric. The unified monitored fabric may span multiple hierarchical levels including in-rack optical links, board-level optical engines, co-packaged optics, optical chiplets, package-level couplers, and/or optical switching paths. The unified monitored fabric may provide visibility into optical paths between the distributed computing components that would not be visible to network-level monitoring of links between separate network devices.

Fault detection system 160 may correlate optical power measurements with component actions at a package level to detect faults that would not be visible to network-level monitoring. For example, the fault detection system 160 may receive optical measurements from optical interconnect 1 150, optical interconnect 2 130, and/or optical interconnect 3 170, and may correlate the optical measurements with performance metrics of the distributed computing components to identify degradation patterns or potential faults. In some implementations, fault detection system 160 may correlate a decrease in optical power measured at optical interconnect 1 150 with increased thermal conditions reported by a processor chiplet communicating over that interconnect, enabling the system to determine whether the optical degradation is caused by thermal effects on the laser source or by physical misalignment of the optical coupler. Fault detection system 160 may also correlate error statistics from optical interconnect 2 130 with workload activity spikes on an associated accelerator, identifying whether increased bit error rates correspond to high-bandwidth data transfers that stress the optical link beyond its operational margins.

Monitoring subsystem 164 may collect telemetry from optical circuit switches including MEMS mirror positions and path configuration state. Monitoring subsystem 164 may receive optical measurements including optical power measurements, per-lane measurements, per-wavelength measurements, temperature measurements, error statistics, laser health data, or optical path state data. Monitoring subsystem 164 may process the optical measurements in conjunction with performance metrics of the distributed computing components to detect potential faults within the distributed computing system. For example, monitoring subsystem 164 may detect a gradual decline in optical power levels across multiple wavelength channels of an optical interconnect while simultaneously observing that the associated memory controller reports normal thermal conditions and stable workload activity, indicating that the degradation may originate from aging of the laser source rather than from environmental or operational factors. In another example, monitoring subsystem 164 may identify a correlation between intermittent error spikes on a particular optical lane and synchronization timing anomalies between two processor chiplets, suggesting that the fault may be related to signal integrity issues at the chiplet interface rather than a failure of the optical engine itself. Additionally, monitoring subsystem 164 may observe that per-lane optical power measurements remain within acceptable ranges while bit error rates increase during periods of high workload activity on an accelerator, which may indicate that the optical path is operating near its bandwidth limits and may benefit from traffic rerouting or link rate adjustment.

Action subsystem 166 may trigger automated reconfiguration of optical circuit switches to route traffic around failed optical paths. The action subsystem 166 may generate messages including repair recommendations, alerts, or automated corrective actions based on detected fault domains. The automated corrective actions may include rerouting traffic, lowering link rate, retuning photonic elements, or scheduling maintenance. In this manner, the fault detection system 160 may support system reliability and maintenance by collecting telemetry from optical interconnects, correlating the telemetry with operational context, applying analytics to detect or predict faults, localizing the likely source of the fault, and generating appropriate responses.

In some implementations, action subsystem 166 may automatically adjust the bias current of a degraded laser source to compensate for reduced optical output power, extending the operational lifetime of the component until scheduled maintenance can be performed. Action subsystem 166 may also initiate a graceful workload migration from computing components served by a failing optical path to components connected via healthy optical interconnects, minimizing service disruption while the fault is addressed. Furthermore, action subsystem 166 may dynamically reduce the modulation rate on an optical link experiencing elevated error rates, trading bandwidth for improved signal integrity until the underlying cause of the degradation can be diagnosed and repaired.

In some implementations, fault detection system 160 may generate alerts and recommendations based on detected faults by accessing and correlating data from multiple sources within the distributed computing system. For example, when monitoring subsystem 164 detects that optical power levels at optical interconnect 1 150 have dropped below a threshold value while the associated laser source temperature has increased beyond normal operating parameters, action subsystem 166 may generate an alert indicating imminent laser failure. The alert may include data such as the current optical power reading, the rate of power degradation over time, the laser temperature history, the affected optical path identifier, and the identifiers of the distributed computing components that communicate over the affected path. This data may be stored in a time-series database that maintains historical optical measurements and thermal readings, enabling the system to retrieve trend data and calculate degradation rates. The alert may be transmitted to maintenance personnel via a network interface and may include a recommendation to schedule laser source replacement within a specified timeframe based on the projected failure date calculated from the degradation trend.

In another example, when monitoring subsystem 164 identifies that bit error rates on optical interconnect 2 130 consistently exceed acceptable thresholds during periods when an associated accelerator reports high memory bandwidth utilization, action subsystem 166 may generate a recommendation to reroute a portion of the traffic to an alternate optical path. The recommendation may include data such as the current bit error rate, the correlation coefficient between error rates and workload activity, the available capacity on alternate optical paths, and the estimated performance impact of the rerouting action. This data may be retrieved from a correlation database that stores associations between optical measurements and component performance metrics, as well as from a topology database that maintains information about available optical paths and their current utilization levels. The recommendation may be generated by querying these databases to identify alternate paths with sufficient capacity and acceptable optical health metrics.

In a further example, when monitoring subsystem 164 observes that per-wavelength optical power measurements on a wavelength-division multiplexed link show uneven degradation across channels, with some channels exhibiting significant power loss while others remain stable, action subsystem 166 may generate an alert indicating potential coupler misalignment or wavelength-selective component degradation. The alert may include data such as the per-wavelength power readings, the differential power loss between channels, the physical location of the affected coupler within the system topology, and historical calibration data for the affected optical path. This data may be stored in a component registry database that maintains calibration records and physical location information for optical components and may be retrieved by querying the registry using the optical path identifier associated with the anomalous measurements. The alert may include a recommendation to perform physical inspection and realignment of the coupler, along with estimated downtime and the list of distributed computing components that would be affected during the maintenance procedure.

In some implementations, fault detection system 160 may use the correlation between performance metrics and optical measurements to diagnose issues with specific types of computing components within the distributed computing system. For example, when monitoring subsystem 164 detects elevated bit error rates on an optical interconnect connecting a memory controller to a processor while simultaneously observing that the memory controller reports increased read latency and the processor reports memory access stalls, the system may diagnose a potential memory subsystem issue. The correlation between optical signal degradation and memory performance anomalies may indicate that the memory controller's optical transceiver is experiencing thermal stress due to high memory access rates, or that the optical path between the memory and processor is unable to sustain the required bandwidth for the current memory workload. Action subsystem 166 may generate a recommendation to reduce memory clock speeds, migrate memory-intensive workloads to components with healthier optical paths, or schedule inspection of the memory controller's optical engine.

In another example, fault detection system 160 may correlate optical measurements with processor performance metrics to diagnose processor-related issues. When monitoring subsystem 164 observes intermittent optical power fluctuations on an interconnect serving a processor chiplet while the processor reports increased instruction pipeline stalls and reduced clock frequency due to thermal throttling, the system may determine that the processor's co-packaged optics are being affected by heat generated during intensive computational workloads. The correlation between processor thermal conditions, computational performance degradation, and optical signal instability may enable the system to distinguish between a failing laser source and thermally-induced optical degradation. Action subsystem 166 may generate an alert recommending improved thermal management for the processor package or workload redistribution to reduce thermal stress on the affected processor.

In a further example, fault detection system 160 may correlate optical telemetry with storage subsystem performance metrics to identify storage-related faults. When monitoring subsystem 164 detects increasing error rates on an optical path connecting a storage controller to a network interface while the storage controller reports elevated write latency and queue depth, the system may diagnose that the optical link is becoming a bottleneck for storage operations. The correlation between storage performance degradation and optical link stress may indicate that the storage workload has exceeded the sustainable bandwidth of the optical interconnect, or that the optical components are degrading under sustained high-throughput data transfers. Action subsystem 166 may generate a recommendation to distribute storage traffic across multiple optical paths, reduce the storage write rate, or schedule replacement of the optical components serving the storage subsystem.

The fault detection system may receive optical measurements from a plurality of optical interconnects internal to a distributed computing system. The plurality of optical interconnects may couple distributed computing components of the distributed computing system. Each distributed computing component may include an associated optical communication device that enables optical communication at a package level. The optical interconnects may include various types of optical communication devices and structures that enable high-bandwidth communication between computing components within the distributed computing system.

The optical interconnects may include optical input/output (I/O) chiplets that are co-packaged with central processing units (CPUs) or accelerators. The co-packaged optical I/O chiplets may deliver bidirectional bandwidth up to 8 terabits per second (Tbps) with latency of approximately 10 nanoseconds (ns) per chiplet. The co-packaged optical I/O chiplets may provide reach distances ranging from millimeters to kilometers. The co-packaged optical I/O chiplets may operate at approximately 5 picojoules per bit (pJ/bit) energy efficiency.

The optical interconnects may include Universal Chiplet Interconnect Express (UCIe)-compliant optical interfaces. The UCIe-compliant optical interfaces may enable in-package and off-package interconnect between distributed computing components. The UCIe-compliant optical interfaces may provide standardized communication protocols for optical data transfer between chiplets within a package or between separate packages. The optical interconnects may include on-package waveguides that route optical signals within a package boundary. Furthermore, the on-package waveguides may guide light between optical components located on a common substrate or within a common package enclosure. The on-package waveguides may enable low-latency optical communication between co-located chiplets without requiring external fiber connections. The optical interconnects may also include external laser source arrays that provide optical power to photonic components. The external laser source arrays may generate coherent light that is distributed to multiple optical transmitters or modulators within the distributed computing system. The external laser source arrays may be located separately from the photonic integrated circuits that modulate and detect optical signals.

In some implementations, the optical interconnects may include interposer coupling structures or package coupling structures that couple optical signals between chiplets or packages. The interposer coupling structures may provide optical alignment and signal transfer between optical components mounted on different substrates. The package coupling structures may enable optical communication between separate integrated circuit packages within the distributed computing system.

Other optical interconnects may also be used including board-level optical engines integrated directly in-system for rack-scale artificial intelligence (AI) server deployments. The board-level optical engines may convert electrical signals to optical signals and optical signals to electrical signals at the circuit board level. The board-level optical engines may provide optical connectivity between computing components mounted on a common circuit board or between circuit boards within a server chassis. Furthermore, optical interconnects may include linear pluggable optics (LPO) modules that operate without digital signal processing (DSP) to reduce power, cost, and latency. The LPO modules may provide direct optical-to-electrical conversion without the computational overhead associated with DSP-based signal conditioning. The LPO modules may be suitable for short-reach applications where signal integrity permits operation without DSP correction.

Active optical cables (AOCs) may also be used as optical interconnects. The AOCs may include microlight-emitting diode (MicroLED)-based AOCs that achieve up to 50% lower power consumption than conventional vertical-cavity surface-emitting laser (VCSEL)-based AOCs. The MicroLED-based AOCs may provide energy-efficient optical connectivity for short-reach interconnect applications within the distributed computing system.

Silicon photonics light engines operating at 1.6 terabits per second (T) may be used for rack-scale and row-scale interconnect. The silicon photonics light engines may integrate optical modulators, detectors, and waveguides on a silicon substrate. The silicon photonics light engines may leverage semiconductor manufacturing processes to produce compact and cost-effective optical transceivers. The optical interconnects may include co-packaged optics (CPO) integrated into switch packages. The CPO switch packages may include optics delivering 1.6 Tb/s per port and up to 400 Tb/s total throughput. The CPO switch packages may reduce the distance between switching electronics and optical transceivers to minimize power consumption and latency.

The optical interconnects may include microelectromechanical systems (MEMS)-based optical circuit switches that enable reconfigurable optical paths within the data center fabric. The MEMS-based optical circuit switches may use movable mirror arrays to direct optical signals between different input and output ports. The MEMS-based optical circuit switches may provide dynamic reconfiguration of optical connectivity without requiring optical-to-electrical-to-optical conversion.

Furthermore, optical interconnects may include internal fiber jumpers within a chassis connecting board-level optical components. The internal fiber jumpers may provide flexible optical connections between optical engines or transceivers mounted on different circuit boards within a common enclosure. The internal fiber jumpers may enable modular system designs where optical connectivity can be reconfigured during assembly or maintenance. In addition, optical interconnects may include thermally sensitive resonant elements that require wavelength tuning based on thermal conditions. The thermally sensitive resonant elements may include ring resonators or other photonic structures whose optical properties vary with temperature. The thermally sensitive resonant elements may require active thermal management or wavelength adjustment to maintain proper optical alignment and signal integrity.

The optical interconnects may operate at speeds of 400 gigabits per second (G), 800G, or 1.6T per port. The optical interconnects may operate using single-mode direct reach (DR) or far reach (FR) style optics for AI fabric applications. The optical interconnects may operate with reach distances ranging from under 2 meters for in-rack links to 100 meters or more for row-scale and building-scale links.

The plurality of optical interconnects within the distributed computing system may include optical paths at two or more hierarchy levels selected from in-rack optical links, board-level optical engines, co-packaged optics, optical chiplets, package-level couplers, and optical switching paths. The hierarchical organization of optical interconnects may reflect the physical and logical structure of the distributed computing system, where different hierarchy levels serve different communication distances and purposes. For example, optical chiplets and co-packaged optics may provide optical communication at the package level between processor cores, memory controllers, and accelerators within a single integrated circuit package. Board-level optical engines may provide optical communication between components mounted on a common circuit board or between circuit boards within a server chassis. In-rack optical links may provide optical communication between servers or computing nodes within a single rack enclosure. Optical switching paths may provide reconfigurable optical connectivity that spans multiple racks or extends across a data center facility.

The different hierarchy levels of optical interconnects may have distinct operational characteristics, fault modes, and monitoring requirements. Optical chiplets and co-packaged optics operating at the package level may be sensitive to thermal conditions generated by adjacent processing elements and may experience degradation patterns that correlate with computational workload intensity. Board-level optical engines may be affected by mechanical stress, vibration, or thermal cycling that occurs within the server chassis. In-rack optical links may be susceptible to connector contamination, fiber bend radius violations, or cable routing issues that arise during system assembly or maintenance. Optical switching paths may experience faults related to switch configuration errors, mirror positioning accuracy in MEMS-based switches, or wavelength alignment in wavelength-selective switches. By monitoring optical interconnects across multiple hierarchy levels, the fault detection system may identify faults that manifest at specific levels of the system architecture and may distinguish between faults that originate at different points within the optical communication path.

Monitoring across multiple hierarchy levels may enable comprehensive fault detection that would not be possible when monitoring only a single level of the optical interconnect hierarchy. For example, a fault that originates at a package-level coupler may cause optical signal degradation that propagates through board-level optical engines and in-rack optical links. By collecting optical telemetry from each hierarchy level, the fault detection system may trace the degradation pattern back to its source and identify the package-level coupler as the fault domain. Similarly, a fault in an optical switching path may affect multiple downstream optical interconnects at lower hierarchy levels. The fault detection system may correlate optical measurements across hierarchy levels to determine that the root cause of widespread signal degradation is a misconfigured optical switch rather than multiple independent component failures. The multi-level monitoring approach may also enable the fault detection system to detect emerging faults at higher hierarchy levels before the faults propagate to affect lower hierarchy levels, supporting proactive maintenance and fault prevention.

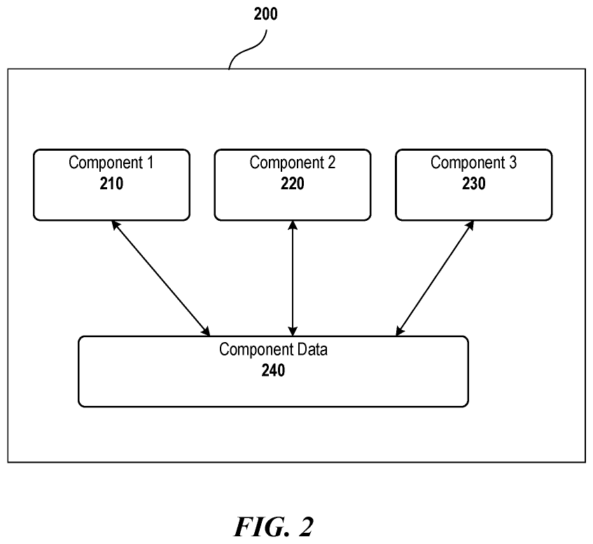

FIG. 2 illustrates a fault detection system 200 for monitoring optical computing components within a distributed computing system. Fault detection system 200 may include a Component 1 210, a Component 2 220, a Component 3 230, and a Component Data 240. Component 1 210, Component 2 220, and Component 3 230 may represent distributed computing components of the distributed computing system that are coupled by optical interconnects.

Fault detection system 200 may provide a way to monitor computing components that communicate using optical connections. Fault detection system 200 may receive optical measurements from a plurality of optical interconnects internal to a distributed computing system. The plurality of optical interconnects may couple distributed computing components of the distributed computing system. Each distributed computing component may include an associated optical communication device that enables optical communication at a package level. For example, fault detection system 200 may collect optical power readings and signal quality data from fiber optic links, waveguides, optical engines, and photonic integrated circuits that connect Component 1 210, Component 2 220, and Component 3 230 within a data center rack or across multiple racks.

Each of Component 1 210, Component 2 220, and Component 3 230 may include an associated optical communication device that enables optical communication at a package level. The optical communication device may include co-packaged optics, optical chiplets, optical engines, or other photonic components that are integrated with or attached to the computing component. The optical communication device may convert electrical signals to optical signals for transmission over optical interconnects and may convert received optical signals back to electrical signals for processing by the computing component.

Component 1 210, Component 2 220, and Component 3 230 may include accelerators such as graphics processing units (GPUs) or tensor processing units (TPUs) that utilize optical input/output (I/O) for high-bandwidth communication. The accelerators may include co-packaged optical I/O chiplets that deliver bidirectional bandwidth for communication with other computing components within the distributed computing system. The accelerators may communicate with memory controllers, processors, and other accelerators over optical interconnects that span distances from millimeters to kilometers.

Component 1 210, Component 2 220, and Component 3 230 may include network interface cards (NICs) with integrated optical communication capabilities. The NICs may include optical transceivers, optical engines, or co-packaged optics that enable high-bandwidth optical communication between computing components and network switches within the distributed computing system. The NICs may support optical communication at speeds of 400 gigabits per second (Gbps), 800 Gbps, or 1.6 terabits per second (Tbps) per port.

Component 1 210, Component 2 220, and Component 3 230 may include top-of-rack (ToR) switches with co-packaged optics or pluggable optical modules. The ToR switches may include optical transceivers in form factors such as quad small form-factor pluggable double density (QSFP-DD) or octal small form-factor pluggable (OSFP). The ToR switches may include co-packaged optics that integrate optical components directly into the switch package to reduce power consumption and latency. The ToR switches may provide optical connectivity between computing components within a rack and between racks within the distributed computing system.

Component Data 240 may be connected to Component 1 210, Component 2 220, and Component 3 230 via bidirectional communication paths. Component Data 240 may store or process data associated with the distributed computing components. The data may include optical measurements from optical interconnects coupling the components and performance metrics such as workload activity, synchronization behavior, or thermal conditions. The bidirectional connections between Component Data 240 and each of Component 1 210, Component 2 220, and Component 3 230 may enable the collection of optical telemetry and operational data from the distributed computing components. The fault detection system 200 may use the collected data to detect potential faults and determine fault domains within the distributed computing system.

The fault detection system may provide a way to collect optical telemetry data from optical communication paths within a distributed computing system. The fault detection system may receive optical measurements from a plurality of optical interconnects internal to the distributed computing system. The plurality of optical interconnects may couple distributed computing components of the distributed computing system. Each distributed computing component may include an associated optical communication device that enables optical communication at a package level. For example, the fault detection system may collect optical telemetry by querying optical transceivers, optical engines, and photonic integrated circuits that connect processors, memory controllers, accelerators, and network interfaces within the distributed computing system.

The fault detection system may collect various types of optical measurements to monitor the health and performance of optical interconnects. The optical measurements may include one or more of optical power measurements, per-lane measurements, per-wavelength measurements, temperature measurements, error statistics, laser health data, or optical path state data. For example, the fault detection system may query optical transceivers to retrieve optical power readings at transmit and receive ports, collect per-lane signal quality metrics from multi-lane parallel optical interfaces, and gather per-wavelength power levels from wavelength-division multiplexed optical links. In some implementations, the optical measurements may include optical power measurements indicating the strength of optical signals transmitted and received over optical interconnects. For example, the fault detection system may sample optical power levels at regular intervals from photodetectors within optical engines and store the sampled values in a time-series database for trend analysis.

The optical measurements may also include per-lane measurements indicating signal characteristics for individual lanes within multi-lane optical interconnects. For example, the fault detection system may collect signal-to-noise ratio values, eye diagram parameters, and modulation amplitude measurements for each lane of a parallel optical interface operating at 400 gigabits per second or higher. Furthermore, the optical measurements may include per-wavelength measurements indicating optical characteristics for individual wavelength channels within wavelength-division multiplexed optical links. For example, the fault detection system may monitor optical power levels and signal quality metrics for each wavelength channel in a dense wavelength-division multiplexed interconnect. In addition, the optical measurements may include temperature measurements indicating thermal conditions of optical components within optical interconnects. For example, the fault detection system may collect temperature readings from thermistors embedded within laser diodes, optical modulators, and photodetectors to monitor thermal stress on optical components.

In some implementations, the fault detection system may collect optical measurements and performance metrics through polling mechanisms that periodically query optical transceivers, optical engines, and computing components for current telemetry values. The collected measurements and metrics may be transmitted to a centralized data store or distributed database that maintains time-series records of optical telemetry and component operational data. The fault detection system may use standardized management interfaces such as Common Management Interface Specification (CMIS) for optical modules or platform management protocols to retrieve telemetry from diverse optical components within the distributed computing system. The stored data may be indexed by component identifier, optical path identifier, and timestamp to enable efficient retrieval and correlation during fault detection analysis.

The optical measurements may include error statistics indicating data transmission errors occurring on optical links. For example, the fault detection system may collect bit error rate (BER) and forward error correction (FEC) statistics indicating error rates and correction activity on optical links. The BER and FEC statistics may indicate the frequency of bit errors detected and corrected during optical data transmission. The fault detection system may detect transmission errors by monitoring cyclic redundancy check (CRC) failures and frame check sequence (FCS) errors at the data link layer. The fault detection system may obtain error statistics by querying error counters maintained within optical transceivers and network interface controllers that track cumulative error events over configurable time intervals. In some implementations, the fault detection system may correlate error bursts with specific time windows to identify intermittent faults that occur under particular operational conditions or traffic patterns. The fault detection system may also retrieve pre-FEC and post-FEC error counts to distinguish between correctable errors that indicate marginal link quality and uncorrectable errors that indicate more severe optical path degradation.

The fault detection system may provide a way to collect operational data about how distributed computing components are functioning within the distributed computing system. The fault detection system may receive performance metrics of the distributed computing components including one or more of workload activity, synchronization behavior, or thermal conditions associated with the distributed computing components. For example, the fault detection system may gather data indicating processor utilization levels, memory access rates, timing coordination between components, and temperature readings from sensors on each distributed computing component.

Furthermore, the fault detection system may receive workload activity data from the distributed computing components. Workload activity may indicate the computational load, memory bandwidth utilization, or data transfer rates of each distributed computing component. For example, the fault detection system may query accelerators to retrieve current processing utilization percentages, memory controllers to obtain read and write operation counts, and network interfaces to collect packet transmission rates over configurable time intervals.

The fault detection system may retrieve workload activity data through multiple collection mechanisms depending on the type of distributed computing component. For accelerators such as GPUs and TPUs, the fault detection system may query hardware performance counters exposed through driver interfaces or management APIs to obtain metrics including streaming multiprocessor utilization, tensor core activity, memory bandwidth consumption, and kernel execution statistics. The fault detection system may access GPU management libraries or vendor-specific monitoring interfaces to retrieve real-time utilization percentages, active thread counts, and compute queue depths from each accelerator within the distributed computing system.

For processors, the fault detection system may collect workload activity data by reading performance monitoring unit (PMU) registers that track instruction throughput, cache hit rates, memory access patterns, and pipeline stall events. The fault detection system may query operating system interfaces or hypervisor management layers to obtain CPU utilization percentages, context switch frequencies, and interrupt handling rates for each processor core. The fault detection system may also retrieve workload scheduling information from job schedulers or orchestration systems to correlate optical measurements with specific computational tasks executing on the distributed computing components.

For memory controllers, the fault detection system may obtain workload activity metrics by querying memory subsystem telemetry interfaces that report read and write transaction counts, memory channel utilization, refresh cycle frequencies, and error correction activity. The fault detection system may access memory controller registers or platform management controllers to retrieve bandwidth utilization statistics and queue occupancy levels that indicate memory access intensity.

For network interfaces, the fault detection system may collect workload activity data by querying network interface controller statistics including packet transmission rates, byte counts, queue depths, and flow control events. The fault detection system may retrieve remote direct memory access (RDMA) operation counts, completion queue statistics, and congestion notification events from network interfaces that support high-performance computing workloads. The collected workload activity data may be timestamped and stored in conjunction with optical measurements to enable temporal correlation during fault detection analysis.

The fault detection system may also receive synchronization behavior data from the distributed computing components. Synchronization behavior may indicate timing relationships, clock coordination, or data exchange patterns between distributed computing components that communicate over optical interconnects. For example, the fault detection system may collect timing offset measurements between processor chiplets, synchronization event counts between memory controllers and accelerators, and coordination latency values between network interfaces and switches.

The fault detection system may retrieve synchronization behavior data through multiple collection mechanisms depending on the type of synchronization being monitored and the distributed computing components involved. For processor chiplets that communicate over optical interconnects, the fault detection system may query phase-locked loop (PLL) status registers and clock distribution network monitors to obtain timing offset measurements indicating the phase relationship between clock domains on different chiplets. The fault detection system may access chiplet management interfaces to retrieve clock skew values, jitter measurements, and frequency drift statistics that indicate the quality of timing coordination between processor chiplets connected via optical links.

For memory controllers and accelerators that require coordinated data transfers, the fault detection system may collect synchronization event counts by querying hardware synchronization primitives and barrier completion counters. The fault detection system may monitor memory fence operation latencies, cache coherence protocol message counts, and atomic operation completion times to characterize synchronization behavior between memory subsystems and compute elements. The fault detection system may also retrieve synchronization queue depths and wait times from accelerator management interfaces to identify synchronization bottlenecks that may correlate with optical interconnect performance.

For network interfaces and switches that participate in distributed synchronization protocols, the fault detection system may collect coordination latency values by monitoring precision time protocol (PTP) message exchanges and timestamp comparison results. The fault detection system may query network interface controllers to obtain synchronization message round-trip times, clock offset corrections, and synchronization state machine transitions. The fault detection system may also retrieve collective operation timing data from high-performance computing communication libraries to characterize synchronization patterns during distributed workloads such as all-reduce operations or barrier synchronizations that generate coordinated traffic patterns across optical interconnects.

The fault detection system may receive thermal conditions data from the distributed computing components. Thermal conditions may indicate temperature readings from sensors embedded within or adjacent to distributed computing components and associated optical communication devices. For example, the fault detection system may collect temperature values from thermistors located on processor packages, accelerator modules, memory controllers, and optical engines to monitor heat generation during operation.

The fault detection system may also receive routing change metrics from the distributed computing system. Routing changes may indicate modifications to data paths within the distributed computing system that affect optical path utilization. For example, the fault detection system may collect data indicating when traffic is redirected from one optical interconnect to another optical interconnect, when load balancing algorithms modify path assignments, or when failover events cause traffic to shift between optical paths. The routing change metrics may enable the fault detection system to correlate changes in optical measurements with corresponding changes in traffic patterns across the distributed computing system.

The fault detection system may receive optical switching events from the distributed computing system. Optical switching events may indicate when reconfigurable optical paths are modified within the distributed computing system. For example, the fault detection system may collect data indicating when microelectromechanical systems (MEMS)-based optical circuit switches reconfigure mirror positions, when wavelength-selective switches modify channel assignments, or when optical path controllers establish new connections between distributed computing components. The optical switching events may enable the fault detection system to distinguish between optical measurement changes caused by path reconfiguration and optical measurement changes caused by component degradation or failure.

The performance metrics may provide operational context for correlating with optical measurements collected from the plurality of optical interconnects. The fault detection system may normalize and correlate the optical measurements with component-level operational performance metrics including one or more of the workload activity of each distributed computing component, the synchronization behavior between the distributed computing components, or the thermal conditions of the distributed computing components. For example, the fault detection system may normalize optical power measurements to a common scale and correlate the normalized optical power measurements with corresponding workload activity levels to identify whether optical signal degradation corresponds to periods of high computational load. The fault detection system may also correlate error statistics from optical interconnects with synchronization behavior data to determine whether transmission errors correspond to timing anomalies between distributed computing components. Furthermore, the fault detection system may correlate temperature measurements from optical components with thermal conditions of adjacent distributed computing components to identify whether optical degradation is caused by heat transfer from computing elements to optical communication devices.

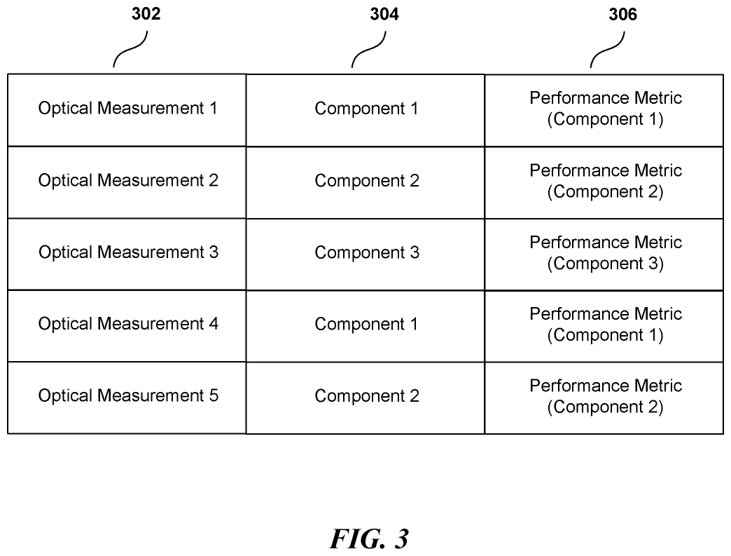

FIG. 3 illustrates a data structure for correlating optical measurements with components and performance metrics within a distributed computing system. The fault detection system 160 may provide a way to organize and associate optical telemetry data with the distributed computing components that generate or receive optical signals over optical interconnects. The fault detection system 160 may use the data structure to enable fault detection and analysis by linking optical measurements with component-level operational data.

The data structure may include an optical measurement field 302, a component field 304, and a performance metric field 306. Optical measurement field 302 may contain entries representing different optical telemetry readings collected from optical interconnects within the distributed computing system. For example, optical measurement field 302 may store optical power measurements, per-lane measurements, per-wavelength measurements, temperature measurements, error statistics, laser health data, or optical path state data collected from optical interconnects coupling distributed computing components.

Component field 304 may identify which distributed computing component is associated with each optical measurement stored in the optical measurement field 302. Fault detection system 160 may identify, for each optical measurement of the optical measurements, a corresponding associated optical path. Fault detection system 160 may determine, for each corresponding optical path, a set of distributed computing system components associated with each optical path. For example, fault detection system 160 may query a topology database to retrieve the identifiers of distributed computing components that communicate over the optical path from which each optical measurement was collected. Component field 304 may store the component identifiers corresponding to each optical measurement, enabling fault detection system 160 to associate optical telemetry with the distributed computing components involved in optical communication.

Performance metric field 306 may contain corresponding performance metrics for each component identified in component field 304. Fault detection system 160 may determine, based on corresponding directions of communication, a correlation between each optical measurement of the optical measurements and one or more corresponding performance metrics with the received performance metrics. For example, when an optical measurement is collected from an optical interconnect carrying data from a first distributed computing component to a second distributed computing component, fault detection system 160 may correlate the optical measurement with performance metrics of the first distributed computing component acting as a transmitter and performance metrics of the second distributed computing component acting as a receiver. Performance metric field 306 may store workload activity, synchronization behavior, or thermal conditions associated with the distributed computing components identified in component field 304.

Fault detection system 160 may link the optical measurements with the one or more corresponding performance metrics prior to inputting into the artificial intelligence model. For example, fault detection system 160 may join records from the optical measurement field 302 with corresponding records from performance metric field 306 based on the component identifiers stored in component field 304. The linked data may be formatted as input vectors or feature sets that the artificial intelligence model may process to detect potential faults within the distributed computing system.

The data structure may associate multiple optical measurements with the same distributed computing component. For example, a first optical measurement and a fourth optical measurement stored in the optical measurement field 302 may both be associated with a first component identifier stored in the component field 304, and both optical measurements may be linked with performance metrics of the first component stored in the performance metric field 306. Fault detection system 160 may use the multiple optical measurements associated with the same component to identify degradation patterns or anomalies that affect a particular distributed computing component across multiple optical paths. The correlation between optical measurements and component-level performance metrics may enable fault detection system 160 to determine whether optical degradation corresponds to operational conditions of the distributed computing components, such as periods of high workload activity or elevated thermal conditions.

Fault detection system 160 may employ multiple mechanisms for correlating optical measurements with performance metrics to enable accurate fault detection and diagnosis within the distributed computing system. In some implementations, fault detection system 160 may use temporal alignment of optical measurements and performance metrics based on synchronized timestamps. Fault detection system 160 may collect optical measurements and performance metrics with associated timestamps indicating when each measurement was recorded. Fault detection system 160 may align optical measurements with performance metrics that were collected within a configurable time window, such as within 100 milliseconds of each other. For example, when fault detection system 160 detects a sudden decrease in optical power at an optical interconnect, the system may retrieve performance metrics from the distributed computing components communicating over that interconnect that were recorded within the same time window. The temporal alignment may enable the fault detection system 160 to identify whether optical degradation events coincide with specific operational conditions such as workload spikes, thermal excursions, or synchronization anomalies. Fault detection system 160 may store timestamped optical measurements and performance metrics in a time-series database that supports efficient range queries for retrieving correlated data within specified time intervals.

A second correlation mechanism may involve directional association based on the communication topology of the distributed computing system. Fault detection system 160 may determine the direction of data flow over each optical interconnect and associate optical measurements with performance metrics of the appropriate transmitting and receiving components. For example, when an optical interconnect carries data from a first accelerator to a second accelerator, fault detection system 160 may correlate transmit-side optical power measurements with workload activity of the first accelerator and correlate receive-side optical power measurements with workload activity of the second accelerator. The directional association may enable fault detection system 160 to distinguish between faults originating at the transmitter side and faults originating at the receiver side of an optical link. The fault detection system may query a topology database that maintains information about the endpoints and directionality of each optical path to determine the appropriate directional associations for correlation.

A third correlation mechanism may involve statistical analysis of optical measurement trends in relation to performance metric patterns over extended time periods. The fault detection system may compute correlation coefficients between optical measurement time series and performance metric time series to identify relationships that persist across multiple measurement intervals. For example, fault detection system 160 may calculate a Pearson correlation coefficient between optical power measurements collected over a 24-hour period and corresponding thermal condition readings from an adjacent processor package to determine whether optical power degradation correlates with processor temperature increases. The statistical correlation mechanism may enable fault detection system 160 to identify gradual degradation patterns that emerge over time rather than sudden fault events. The fault detection system may apply sliding window analysis to compute rolling correlation values that track how the relationship between optical measurements and performance metrics evolves as operating conditions change within the distributed computing system.

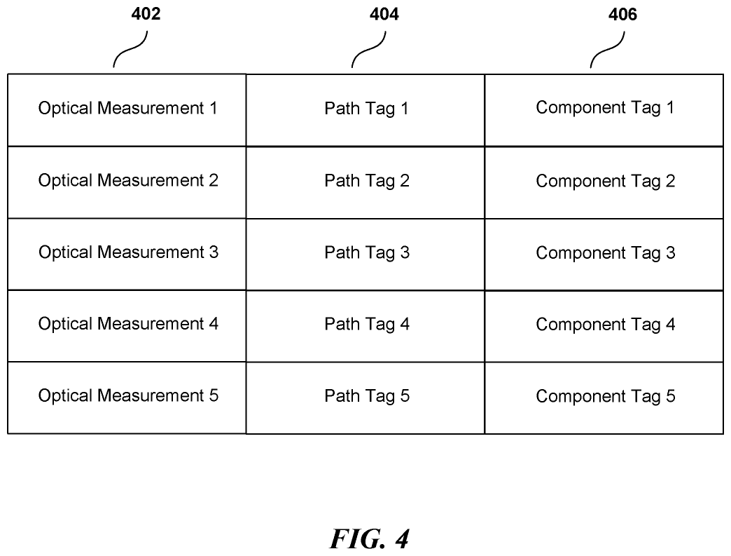

FIG. 4 illustrates a data structure for organizing optical measurement data with associated tagging information for optical interconnect monitoring within a distributed computing system. The fault detection system may use the data structure to link optical telemetry data with topology and component information prior to input into an artificial intelligence model for fault detection.

The fault detection system may provide a way to associate optical measurements with the physical topology of the distributed computing system. In particular, the fault detection system may determine a plurality of optical paths associated with the distributed computing components. Each optical path of the plurality of optical paths may be associated with two or more distributed computing components. For example, fault detection system 160 may query a topology database to identify optical paths that connect processors, memory controllers, accelerators, and network interfaces within the distributed computing system. The data structure may include an optical measurement field 402, a path tag field 404, and a component tag field 406. Optical measurement field 402 may contain entries representing individual optical measurements collected from optical interconnects within the distributed computing system. For example, optical measurement field 402 may store optical power measurements, per-lane measurements, per-wavelength measurements, temperature measurements, error statistics, laser health data, or optical path state data collected from optical interconnects coupling distributed computing components.

The fault detection system 160 may provide a way to indicate which optical path corresponds to each optical measurement. The fault detection system 160 may generate a plurality of path tags within the optical measurements to indicate a corresponding optical path for each measurement of the optical measurements. The path tag field 404 may contain entries indicating the optical path associated with each respective optical measurement stored in the optical measurement field 402. For example, when the fault detection system 160 collects an optical power reading from an optical interconnect connecting a processor chiplet to a memory controller, the fault detection system 160 may generate a path tag identifying that optical path and store the path tag in the path tag field 404 corresponding to the optical power reading.

Fault detection system 160 may add the plurality of path tags to the optical measurements prior to inputting the optical measurements into the artificial intelligence model. For example, fault detection system 160 may embed path tag identifiers within each optical measurement record before formatting the optical measurement records as input vectors for the artificial intelligence model. The path tags may enable the artificial intelligence model to understand the structural context of each optical measurement within the distributed computing system topology.

The fault detection system 160 may also provide a way to indicate which distributed computing components communicate over each optical path. The fault detection system 160 may determine, for the plurality of optical paths, a corresponding set of components that communicate over each optical path of the plurality of optical paths. For example, the fault detection system 160 may query a topology database to retrieve identifiers of distributed computing components that serve as endpoints for each optical path.

Fault detection system 160 may generate a plurality of component tags within the optical measurements to indicate the corresponding set of components for each optical path of the plurality of optical paths. Component tag field 406 may contain entries identifying the set of distributed computing components that communicate over each corresponding optical path. For example, when monitoring an optical path connecting a first accelerator to a second accelerator, fault detection system 160 may generate component tags identifying both the first accelerator and the second accelerator as endpoints of that optical path.

Furthermore, fault detection system 160 may add the plurality of component tags to the optical measurements prior to inputting the optical measurements into the artificial intelligence model. For example, fault detection system 160 may embed component tag identifiers within each optical measurement record alongside the corresponding path tags. The component tags may enable the artificial intelligence model to associate optical telemetry with the distributed computing components involved in optical communication over each optical path. Each row of the data structure may associate a single optical measurement from optical measurement field 402 with a corresponding path tag from path tag field 404 and a corresponding component tag from component tag field 406. The association may link optical telemetry data with topology and component information, enabling the artificial intelligence model to process the optical measurements with awareness of the physical structure and component relationships within the distributed computing system. The fault detection system may use the tagged optical measurements to detect potential faults and determine fault domains based on patterns that emerge across optical paths and associated distributed computing components.

The fault detection system may generate tagged telemetry records that consolidate optical measurements with contextual information for input into the artificial intelligence model. For each optical measurement collected from the plurality of optical interconnects, the fault detection system may generate a tagged telemetry record comprising a corresponding optical measurement obtained from a corresponding optical path, a path identifier for the corresponding optical path, one or more component identifiers for one or more components associated with the corresponding optical path, and at least one component operational metric associated with a communication direction over the corresponding optical path. The tagged telemetry records may provide a structured representation that links optical telemetry data with topology information and component-level operational context, enabling the artificial intelligence model to process the optical measurements with awareness of the physical structure and operational state of the distributed computing system.

The tagged telemetry record may include the corresponding optical measurement as a primary data element. The corresponding optical measurement may include one or more of optical power measurements, per-lane measurements, per-wavelength measurements, temperature measurements, error statistics, laser health data, or optical path state data collected from the corresponding optical path. The path identifier may uniquely identify the corresponding optical path within the distributed computing system topology, enabling the fault detection system to associate the optical measurement with a specific optical interconnect location. The path identifier may correspond to a path tag generated by the fault detection system when determining the plurality of optical paths associated with the distributed computing components.

The one or more component identifiers within the tagged telemetry record may identify the distributed computing components that communicate over the corresponding optical path. For example, when the corresponding optical path connects a processor chiplet to a memory controller, the tagged telemetry record may include component identifiers for both the processor chiplet and the memory controller. The component identifiers may correspond to component tags generated by the fault detection system when determining the set of components that communicate over each optical path. The component identifiers may enable the artificial intelligence model to associate the optical measurement with the specific distributed computing components involved in optical communication over the corresponding optical path.

The at least one component operational metric associated with a communication direction over the corresponding optical path may provide operational context that corresponds to the direction of data flow over the optical interconnect. When the corresponding optical path carries data in a first direction from a transmitting component to a receiving component, the tagged telemetry record may include component operational metrics from the transmitting component that are relevant to the transmission of optical signals, such as workload activity generating outbound data traffic or thermal conditions affecting the optical transmitter. The tagged telemetry record may also include component operational metrics from the receiving component that are relevant to the reception of optical signals, such as synchronization behavior indicating timing coordination with the transmitting component or workload activity consuming inbound data. By associating component operational metrics with the communication direction, the fault detection system may enable the artificial intelligence model to correlate optical measurements with the operational state of the appropriate component based on whether the component is transmitting or receiving data over the corresponding optical path.

The fault detection system may use machine learning/artificial intelligence to identify problems/faults in the computing environment. The fault detection system may input the optical measurements from the plurality of optical interconnects and the performance metrics of the distributed computing components into an artificial intelligence model to detect potential faults within the distributed computing system. The artificial intelligence model may have been trained to predict the potential faults based on received optical measurements and received performance metrics. For example, fault detection system 160 may format the collected optical telemetry and component operational data as input vectors and provide the input vectors to a neural network that has learned patterns associated with component failures from historical data.

The fault detection system may also provide a mechanism to prepare telemetry data from different types of optical links for processing by the artificial intelligence model. The operation of inputting into the artificial intelligence model may include normalizing telemetry from heterogeneous optical interconnect types. The heterogeneous optical interconnect types may include direct attach copper (DAC) links, active electrical cables (AEC), active optical cables (AOC), linear pluggable optics (LPO), and co-packaged optics (CPO) links. For example, fault detection system 160 may apply scaling factors and unit conversions to optical power measurements, error statistics, and temperature readings collected from different optical interconnect types so that the measurements are represented on a common scale prior to input into the artificial intelligence model.

Fault detection system 160 may provide a way to account for different operational modes of optical links when detecting faults. The operation of detecting potential faults may include mode selection analytics that account for whether links operate in digital signal processing (DSP)-retimed mode or linear pluggable optic (LPO) mode. For example, fault detection system 160 may determine the operational mode of each optical interconnect and apply mode-specific analysis parameters when processing optical measurements from DSP-retimed links versus LPO links that operate without DSP. The mode selection analytics may enable the artificial intelligence model to distinguish between normal operational variations associated with each mode and anomalous patterns that indicate potential faults.

The artificial intelligence model may provide a mechanism to identify patterns that indicate degradation under specific operating conditions. In particular, the artificial intelligence model may identify degradation patterns associated with specific workload types determined from a combination of the optical measurements and the performance metrics. For example, the artificial intelligence model may learn that certain optical degradation signatures occur when accelerators execute memory-intensive workloads, while different degradation patterns emerge during compute-intensive workloads. The combination of optical telemetry with workload activity data may enable the artificial intelligence model to detect faults that manifest under particular operational conditions.

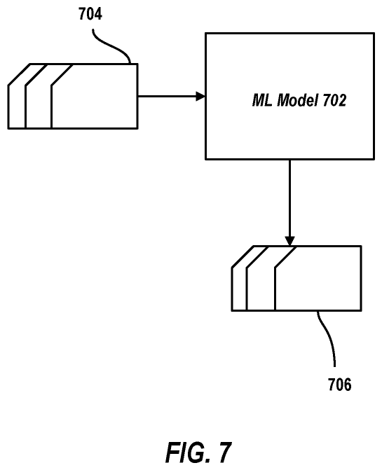

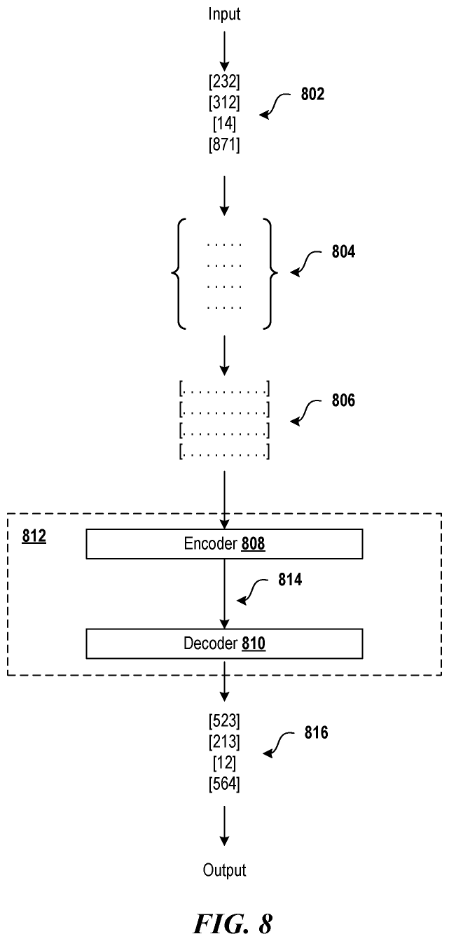

The artificial intelligence model may be trained using historical data collected from distributed computing systems. In particular, the artificial intelligence model may be trained using historical optical measurements correlated with observed fault events, corresponding fault domains, and component-level operational performance metrics collected at corresponding optical interconnects of distributed computing systems. The corresponding optical interconnects may include one or more of in-rack optical links, board-level optical engines, co-packaged optics, optical chiplets, package-level couplers, or optical switching paths. For example, the training data may include time-series records of optical power measurements, error statistics, and laser health data collected from optical interconnects prior to and during observed fault events, along with labels indicating the fault domain that was determined to be the source of each fault. The artificial intelligence model may use the training data to learn associations between patterns in optical measurements and performance metrics and the corresponding fault domains within the distributed computing system. Some examples of the artificial intelligence models are described in relation to FIG. 7 and FIG. 8.

The fault detection system may provide a way to pinpoint where a problem is occurring within the computing architecture. In particular, the fault detection system may determine, based on one or more potential faults, a fault domain within the distributed computing system. The fault domain may include one or more of a processor fault where a processor chiplet exhibits degraded optical transceiver performance due to thermal stress or aging of the co-packaged optical components, a memory controller fault where the optical interface between a memory controller and associated memory modules experiences signal degradation affecting data transfer reliability, or an accelerator fault where an optical engine integrated with a graphics processing unit or tensor processing unit shows declining optical power output or increased error rates during high-bandwidth data transfers.

The fault domain may also include one or more of a chiplet interface, an optical engine, a laser source, a coupler, or a reconfigurable optical path. For example, when the artificial intelligence model detects anomalous patterns in optical measurements and performance metrics, the fault detection system may identify that the issue originates from a degraded laser source within a co-packaged optical assembly or from a misaligned coupler at a package boundary.

The fault detection system may provide a way to identify faults related to cooling system interactions with optical components. The fault domain may include a liquid-cooling interaction fault where cooling system operation affects optical assembly performance in co-packaged photonic switches. For example, the fault detection system may detect that vibrations or temperature fluctuations caused by liquid cooling pumps correlate with intermittent optical power variations in co-packaged optical assemblies, and the fault detection system may determine that the fault domain includes the interaction between the cooling system and the photonic switch package.

The fault detection system may provide a way to identify faults at chiplet boundaries within a distributed computing component. The fault domain may include a degraded chiplet coupling fault where the optical interface between chiplets experiences degradation. For example, the fault detection system may correlate increased bit error rates on an optical path with reduced signal quality at the interface between an optical input/output chiplet and an adjacent processor chiplet, and the fault detection system may determine that the fault domain includes the chiplet coupling structure.

The fault detection system may provide a way to identify faults in reconfigurable optical switching systems. The fault domain may include an optical path misconfiguration fault in optical circuit switching systems where paths are incorrectly configured. For example, the fault detection system may detect that optical power measurements indicate signal loss on a path that was recently reconfigured by a microelectromechanical systems (MEMS)-based optical circuit switch, and the fault detection system may determine that the fault domain includes the optical circuit switch path configuration.

The fault detection system may provide a way to identify faults in shared laser sources that provide optical power to multiple photonic components. The fault domain may include an external laser degradation fault where shared laser sources experience reduced output power or wavelength drift. For example, the fault detection system may detect that multiple optical paths served by a common external laser source exhibit simultaneous power degradation, and the fault detection system may determine that the fault domain includes the external laser source rather than individual optical paths.

The fault detection system may provide a way to identify faults related to mechanical alignment of optical coupling structures. The fault domain may include a package-level alignment fault where mechanical alignment of optical coupling structures has shifted. For example, the fault detection system may detect that optical power measurements at a package-level coupler have degraded following thermal cycling or mechanical stress events, and the fault detection system may determine that the fault domain includes the alignment of the optical coupling structure at the package boundary.

The fault detection system may provide a way to identify faults caused by temperature variations affecting optical component performance. The fault domain may include a thermal drift fault in co-packaged photonics where temperature changes affect optical component performance. For example, the fault detection system may correlate wavelength drift in thermally sensitive resonant elements with temperature excursions reported by thermal sensors on an adjacent processor, and the fault detection system may determine that the fault domain includes thermal drift affecting the photonic components within the co-packaged optical assembly.

The fault detection system may provide a way to identify faults in fiber optic connections within rack enclosures. The fault domain may include a bent or contaminated fiber fault within rack-internal optical links. For example, the fault detection system may detect increased insertion loss or back-reflection on an internal fiber jumper connecting board-level optical components, and the fault detection system may determine that the fault domain includes a bent or contaminated fiber segment within the rack.

The fault detection system may provide a way to identify faults in individual lanes of multi-lane optical links. The fault domain may include a failed optical lane fault in linear pluggable optics (LPO) or active optical cable (AOC) links where individual lanes within a multi-lane link have failed. For example, the fault detection system may detect that per-lane optical power measurements indicate that one or more lanes of a parallel optical interface have dropped below acceptable thresholds while other lanes remain operational, and the fault detection system may determine that the fault domain includes the failed optical lane within the LPO or AOC link.

The fault detection system may provide a way to correlate optical measurements with optical switching events to identify faults in reconfigurable optical paths. The operation of determining the fault domain may include correlating optical measurements with optical switching events to identify faults in reconfigurable optical paths. For example, the fault detection system may receive optical switching events indicating when a MEMS-based optical circuit switch reconfigures mirror positions, and the fault detection system may correlate the timing of optical measurement anomalies with the timing of the optical switching events to distinguish between faults caused by path reconfiguration errors and faults caused by component degradation. The fault detection system may determine that optical power loss occurring immediately after a path reconfiguration event indicates a fault in the optical circuit switch configuration, while optical power loss occurring independently of switching events indicates a fault in the optical path components themselves.

The fault detection system may provide a way to identify faults within specific types of computing components by correlating optical measurements with component-specific performance metrics. For processors, the fault detection system may correlate optical power fluctuations on interconnects serving processor chiplets with processor performance metrics including instruction throughput, pipeline stall counts, and thermal throttling events. For example, the fault detection system may detect that declining optical signal quality on a processor-to-memory optical path coincides with increased memory access latency and reduced instructions per cycle reported by the processor, indicating that the optical degradation is affecting processor performance. The fault detection system may also identify processor faults by detecting correlations between optical error rates and processor clock frequency reductions caused by thermal management responses to heat generated by co-packaged optical components.

For memory controllers and memory devices, the fault detection system may correlate optical measurements with memory subsystem performance metrics including read and write latency, memory bandwidth utilization, and error correction code (ECC) activity. For example, the fault detection system may detect that increased bit error rates on an optical interconnect between a memory controller and a processor correspond to elevated ECC correction counts and increased memory access retry operations reported by the memory subsystem. The fault detection system may identify memory-related faults by observing that optical power degradation on memory-serving optical paths correlates with reduced memory throughput and increased queue depths at the memory controller, indicating that optical signal degradation is limiting memory bandwidth availability.

For storage devices and storage controllers, the fault detection system may correlate optical measurements with storage performance metrics including input/output operations per second, read and write latency, and queue depth. For example, the fault detection system may detect that optical signal degradation on an interconnect serving a storage controller coincides with increased storage access latency and reduced throughput reported by the storage subsystem. The fault detection system may identify storage-related faults by observing that intermittent optical power drops on storage-serving optical paths correlate with storage command timeouts and retry operations, indicating that optical link instability is affecting storage reliability. The fault detection system may further distinguish between faults originating in the storage device optical interface and faults originating in the optical path by comparing optical measurements from multiple storage devices served by common optical infrastructure.

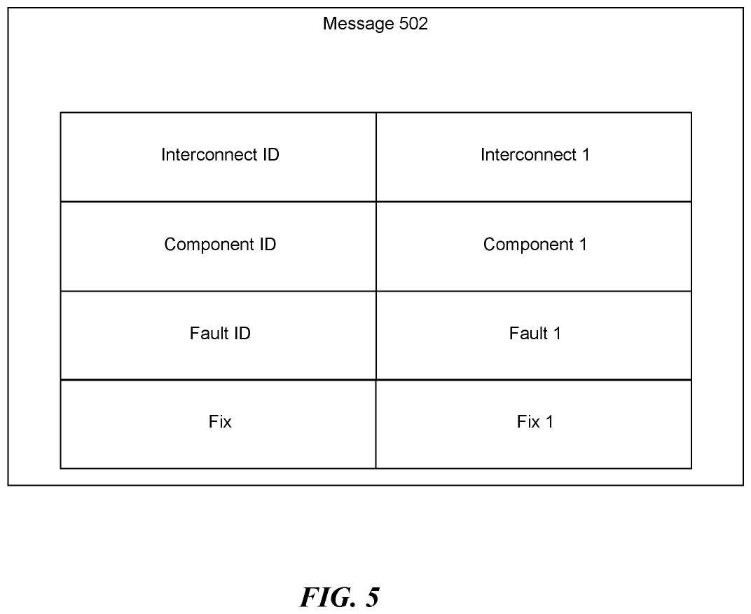

FIG. 5 illustrates a message 502 used for communicating fault information within a distributed computing system. Fault detection system 160 may provide a way to communicate detected issues and take action based on identified fault domains. In particular, fault detection system 160 may generate, based on the fault domain, a message 502 including a repair recommendation, an alert, or an automated corrective action. For example, fault detection system 160 may construct the message 502 by querying a fault database to retrieve the appropriate repair recommendation or corrective action associated with the determined fault domain and populating message 502 with the retrieved information along with identifiers for the affected optical interconnect and distributed computing component.

Message 502 may include an Interconnect ID field that identifies the optical interconnect associated with the fault. The Interconnect ID field may store a value such as Interconnect 1, indicating which optical interconnect of the plurality of optical interconnects is experiencing the detected or predicted fault. For example, fault detection system 160 may populate the Interconnect ID field by retrieving the optical path identifier from the optical measurement data that triggered the fault detection.

Message 502 may include a Component ID field that identifies the distributed computing component related to the fault. The Component ID field may store a value such as Component 1, indicating which distributed computing component is associated with the fault domain. For example, fault detection system 160 may populate the Component ID field by querying the topology database to determine which distributed computing component communicates over the affected optical interconnect.

In some implementations, message 502 may include a Fault ID field that specifies the type or identifier of the detected fault. The Fault ID field may store a value such as Fault 1, representing a classification of the fault based on the output of the artificial intelligence model. For example, fault detection system 160 may assign a Fault ID by mapping the fault domain determined by the artificial intelligence model to a predefined fault classification stored in a fault registry. Furthermore, message 502 may include a Fix field that represents a repair recommendation or corrective action associated with the identified fault domain. The Fix field may store a value such as Fix 1, indicating a specific repair procedure or automated action to address the fault. For example, fault detection system 160 may populate the Fix field by querying a remediation database that associates fault classifications with corresponding repair recommendations or automated corrective actions.

The automated corrective action may include retuning photonic elements within the distributed computing system. For example, fault detection system 160 may detect that wavelength drift in thermally sensitive resonant elements has caused optical signal degradation, and the fault detection system 160 may generate message 502 that triggers automatic adjustment of the resonant element tuning parameters to restore proper wavelength alignment. In some implementations, the automated corrective action may include rerouting traffic within the distributed computing system over a different path. For example, when fault detection system 160 determines that an optical interconnect is experiencing degradation that affects data transmission reliability, fault detection system 160 may generate a message 502 that instructs optical circuit switches to redirect traffic from the degraded optical path to an alternate optical path with acceptable optical health metrics.

In some implementations, the automated corrective action may include lowering the link rate on a degraded optical path to maintain connectivity while reducing error rates. For example, when fault detection system 160 detects elevated bit error rates on an optical interconnect that has not yet failed completely, fault detection system 160 may generate a message that instructs the optical transceiver to reduce the modulation rate, trading bandwidth for improved signal integrity until the underlying cause of the degradation can be diagnosed and repaired. Furthermore, the automated corrective action may include triggering automated reconfiguration of optical circuit switches to route traffic around failed optical paths. For example, when fault detection system 160 determines that a microelectromechanical systems (MEMS)-based optical circuit switch path has failed, the fault detection system 160 may generate a message that instructs the optical circuit switch to reconfigure mirror positions to establish an alternate optical connection between the affected distributed computing components.

In some implementations, the automated corrective action may include responses to faults detected in specific hardware components within the distributed computing system. For processor-related faults, fault detection system 160 may generate a message that triggers workload migration from a processor experiencing optical interconnect degradation to another processor with healthy optical paths, allowing the affected processor to be taken offline for maintenance without disrupting ongoing computations. For example, when fault detection system 160 detects that optical power measurements on interconnects serving a processor chiplet have declined below operational thresholds while the processor reports increased instruction pipeline stalls, fault detection system 160 may initiate automated migration of active workloads to processors connected via optical paths exhibiting acceptable health metrics.

For memory-related faults, the automated corrective action may include reducing memory access rates or activating spare memory channels to compensate for degraded optical connectivity. For example, when fault detection system 160 detects that bit error rates on an optical interconnect between a memory controller and a processor have exceeded acceptable thresholds, fault detection system 160 may generate a message that instructs the memory controller to reduce the memory clock frequency or to redirect memory traffic to alternate memory modules served by optical paths with better signal quality. The fault detection system may also trigger activation of redundant memory paths when available, maintaining memory bandwidth availability while the degraded optical path is scheduled for repair.

For storage-related faults, the automated corrective action may include initiating data replication to alternate storage devices or activating failover to redundant storage controllers. For example, when fault detection system 160 detects that optical signal degradation on an interconnect serving a storage controller correlates with increased storage command timeouts, fault detection system 160 may generate a message that triggers replication of critical data to storage devices connected via healthy optical paths. The fault detection system may also instruct the storage subsystem to redirect input/output operations to a secondary storage controller with acceptable optical connectivity, ensuring continued data availability while the primary storage path is diagnosed and repaired.

The fault detection system may provide a way to monitor optical interconnects as a cohesive monitoring domain across the distributed computing system. The plurality of optical interconnects may include a unified monitored fabric spanning the distributed computing system. The unified monitored fabric may encompass optical paths at multiple hierarchical levels within the distributed computing system, including in-rack optical links, board-level optical engines, co-packaged optics, optical chiplets, package-level couplers, and optical switching paths. For example, the fault detection system may collect optical telemetry from optical interconnects that connect processors to memory controllers within a single package, from optical engines that connect circuit boards within a server chassis, and from fiber optic links that connect servers within a rack, treating all of these optical paths as part of a single monitored domain.

The unified monitored fabric may provide visibility into optical paths between the distributed computing components that would not be visible to network-level monitoring of links between separate network devices. Network-level monitoring may focus on optical links between discrete network devices such as switches, routers, and network interface cards, without providing insight into optical communication occurring within packages, between chiplets, or at board-level optical engines. For example, network-level monitoring may detect degradation on an optical link between a top-of-rack switch and a server network interface, but may not detect degradation on an optical path between a processor chiplet and a memory controller within the server package. The unified monitored fabric may extend monitoring to these internal optical paths, enabling the fault detection system to detect faults that occur at optical interconnects closer to the compute and memory elements themselves.

The unified monitored fabric may enable the fault detection system to correlate optical measurements across multiple levels of the system hierarchy. For example, the fault detection system may correlate optical power measurements from a co-packaged optical assembly with optical measurements from a board-level optical engine and optical measurements from an in-rack fiber link to identify degradation patterns that span multiple interconnect levels. The unified monitored fabric may also enable the fault detection system to trace optical signal paths from package-level optical components through board-level optical engines to rack-level fiber connections, providing end-to-end visibility into optical communication within the distributed computing system.

### Computing Environment

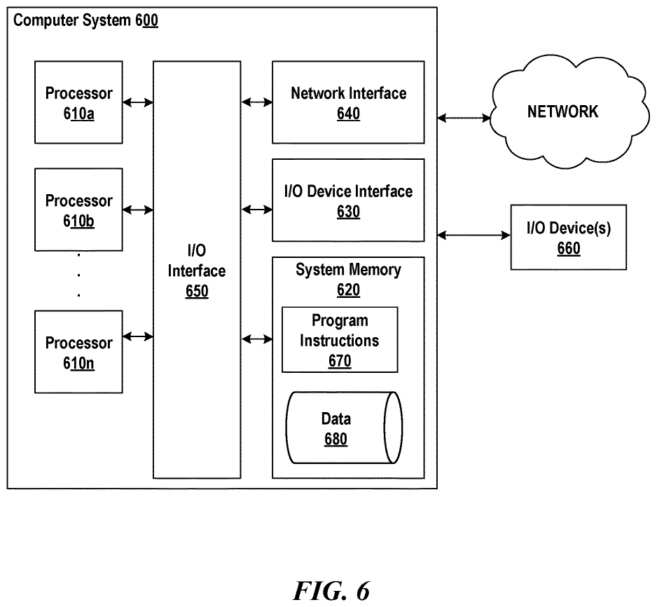

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

FIG. 7 illustrates an exemplary machine learning model 702. According to some examples, the machine learning model may be any model, such as a model for data imputation. For example, the machine learning model may be trained to intake input 704. As a result of inputting the input 704 into the machine learning model, the model may then output an output 706, which may include, for example, an imputed value. Furthermore, as described, the machine learning model may be configured to output a confidence interval or other metric for certainty regarding the outputs. Output 706 may include output parameters.

The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction and reference feedback information (e.g., user indication of accuracy, reference labels, or other information). Connection weights may be adjusted, for example, if the machine learning model is a neural network, to reconcile differences between the neural network's prediction and the reference feedback.

One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function that combines the values of all of its inputs together. Each connection (or the neural unit itself) may have a threshold function that a signal must surpass before it propagates to other neural units. The machine learning model may be self-learning and/or trained rather than explicitly programmed and may perform significantly better in certain areas of problem-solving as compared to computer programs that do not use machine learning. During training, an output layer of the machine learning model may correspond to a classification or imputation of the machine learning model, and an input known to correspond to that classification or imputation value may be input into an input layer of the machine learning model during training. During testing, an input without a known classification or known imputation value may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector. The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”), and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification, etc.) in order to improve the accuracy of outputs (e.g., more accurate predictions) such as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from publicly available sources. Such a technique may be used to identify values and generate a corpus that can be accessed to impute values. For example, in some embodiments, if a value is missing, the model may access the corpus to identify relevant information for the missing value. For example, the values can be used to calculate the missing value. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. The specific training samples may be used to generate language in a certain style or in a certain format.

Some concepts in ML-based language models will now be discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or, in the case of an LLM, may contain millions or billions of learned parameters or more. As non-limiting examples, a language model may generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models may also be used for chatbots (e.g., virtual assistance).

A type of neural network architecture, referred to as a “transformer,” may be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 8 is a block diagram of an example transformer 812. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

Transformer 812 may include an encoder 808 (which may include one or more encoder layers/blocks connected in series) and a decoder 810 (which may include one or more decoder layers/blocks connected in series). Generally, encoder 808 and decoder 810 may each include multiple neural network layers, at least one of which may be a self-attention layer. The parameters of the neural network layers may be referred to as the parameters of the language model.

Transformer 812 may be trained to perform certain functions on a natural language input. Examples of the functions include summarizing existing content, brainstorming ideas, writing a rough draft, fixing spelling and grammar, and translating content. Summarizing may include extracting key points or themes from an existing content in a high-level summary. As described herein, it may take existing content from publicly available sources (e.g., text, images, etc.) to help in imputing missing values. Brainstorming ideas may include generating a list of ideas based on provided input. For example, the ML model may generate a list of names for a startup or costumes for an upcoming party. Writing a rough draft may include generating writing in a particular style that may be useful as a starting point for the user's writing. The style may be identified as, e.g., an email, a blog post, a social media post, or a poem. Fixing spelling and grammar may include correcting errors in an existing input text. Translating may include converting an existing input text into a variety of different languages. In some implementations, transformer 812 is trained to perform certain functions on other input formats than natural language input. For example, the input may include objects, images, audio content, or video content, or a combination thereof. In some examples, this may be used to generate commands for authorizing and completing the transaction, for example.

Transformer 812 may be trained on a text corpus that is labeled (e.g., annotated to indicate verbs, nouns) or unlabeled. LLMs may be trained on a large unlabeled corpus. The term “language model,” as used herein, may include an ML-based language model (e.g., a language model that is implemented using a neural network or other ML architecture), unless stated otherwise. Some LLMs may be trained on a large multi-language, multi-domain corpus to enable the model to be versatile at a variety of language-based tasks such as generative tasks (e.g., generating human-like natural language responses to natural language input).

FIG. 8 illustrates an example of how transformer 812 may process textual input data. Input to a language model (whether transformer-based or otherwise) typically is in the form of natural language that may be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without white space appended. In some implementations, a token may correspond to a portion of a word.

For example, the word “greater” may be represented by a token for [great] and a second token for [er]. In another example, the text sequence “write a summary” may be parsed into the segments [write], [a], and [summary], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a list, a paragraph), an [EOT] token may be another special token that indicates the end of the textual sequence, other tokens can provide formatting information, etc.

In FIG. 8, a short sequence of tokens 802 corresponding to the input text is illustrated as input to transformer 812. Tokenization of the text sequence into tokens 802 may be performed by some pre-processing tokenization module such as, for example, a byte-pair encoding tokenizer (the “pre” referring to the tokenization occurring prior to the processing of the tokenized input by the LLM), which is not shown in FIG. 8 for brevity. In general, the token sequence that is inputted into transformer 812 may be of any length up to a maximum length defined based on the dimensions of transformer 812. Each token 802 in the token sequence is converted into an embedding 806 (also referred to as “embedding vector”).

Embedding 806 is a learned numerical representation (such as, for example, a vector) of a token that captures some semantic meaning of the text segment represented by the token 802. Embedding 806 represents the text segment corresponding to token 802 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, embedding 806 corresponding to the “write” token will be closer to another embedding corresponding to the “jot down” token in the vector space as compared to the distance between the embedding 806 corresponding to the “write” token and another embedding corresponding to the “summary” token.

The vector space may be defined by the dimensions and values of the embedding vectors. Various techniques may be used to convert token 802 into embedding 806. For example, another trained ML model may be used to convert token 802 into embedding 806. In particular, another trained ML model may be used to convert token 802 into embedding 806 in a way that encodes additional information into embedding 806 (e.g., a trained ML model may encode positional information about the position of token 802 in the text sequence into the embedding 806). In some implementations, the numerical value of token 802 may be used to look up the corresponding embedding in an embedding matrix 804, which may be learned during training of transformer 812.

The generated embeddings, e.g., such as embedding 806, are input into the encoder 808. Encoder 808 serves to encode embedding 806 into feature vectors 814 that represent the latent features of embedding 806. Encoder 808 can encode positional information (i.e., information about the sequence of the input) in feature vectors 814. Feature vectors 814 may have very high dimensionality (e.g., on the order of thousands or tens of thousands), with each element in a feature vector corresponding to a respective feature. The numerical weight of each element in a feature vector represents the importance of the corresponding feature. The space of all possible feature vectors, e.g., such as feature vectors 814 that may be generated by encoder 808 may be referred to as a latent space or feature space.

Conceptually, decoder 810 is designed to map the features represented by feature vectors 814 into meaningful output, which may depend on the task that was assigned to transformer 812. For example, if transformer 812 is used for a translation task, decoder 810 may map feature vectors 814 into text output in a target language different from the language of the original tokens 802. Generally, in a generative language model, decoder 810 serves to decode feature vectors 814 into a sequence of tokens. Decoder 810 may generate output tokens 816 one by one. Each output token 816 may be fed back as input to decoder 810 in order to generate the next output token 816. By feeding back the generated output and applying self-attention, decoder 810 may generate a sequence of output tokens 816 that has sequential meaning (e.g., the resulting output text sequence is understandable as a sentence and obeys grammatical rules). Decoder 810 may generate output tokens 816 until a special [EOT] token (indicating the end of the text) is generated. The resulting sequence of output tokens 816 can then be converted to a text sequence in post-processing. For example, each output token 816 may be an integer number that corresponds to a vocabulary index. By looking up the text segment using the vocabulary index, the text segment corresponding to each output token 816 may be retrieved, the text segments may be concatenated together, and the final output text sequence can be obtained.

In some implementations, the input provided to transformer 812 includes instructions to perform a function on an existing text. The output may include, for example, a modified version of the input text and instructions to modify the text. The modification may include summarizing, translating, correcting grammar or spelling, changing the style of the input text, lengthening or shortening the text, or changing the format of the text (e.g., adding bullet points or checkboxes).

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that may then be further processed by a task-specific layer (e.g., a classification layer). BERT is an example of a language model that may be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models may be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system may access a remote language model (e.g., a cloud-based language model), such as ChatGPT or GPT-3, via a software interface (e.g., an API). Additionally or alternatively, such a remote language model may be accessed via a network such as the internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Input(s) to an LLM can be referred to as a prompt, which is a natural language input that includes instructions to the LLM to generate a desired output. A computer system can generate a prompt that is provided as input to the LLM via an API. As described above, the prompt may optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

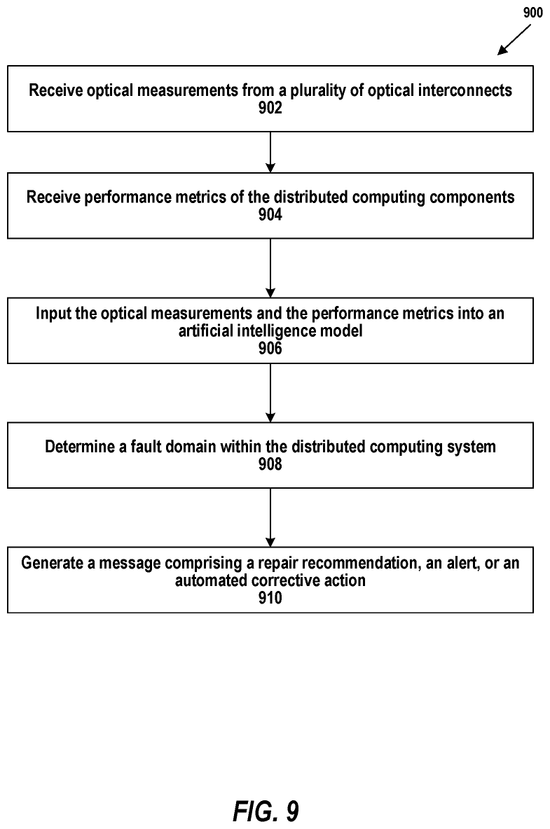

FIG. 9 illustrates a flowchart for a process 900 for monitoring optical interconnects and detecting faults within a distributed computing system. Process 900 may be performed by fault detection system 160 described in relation to FIG. 1. Process 900 may provide a way to collect telemetry from optical interconnects, correlate the telemetry with operational context, apply analytics to detect or predict faults, localize the likely source of the fault, and generate appropriate responses to support system reliability and maintenance.

Fault detection system 160 may provide a way to collect optical telemetry data from optical communication paths within the distributed computing system. Process 900 begins with an operation 902, where fault detection system 160 receives optical measurements from a plurality of optical interconnects. The plurality of optical interconnects may couple distributed computing components within the distributed computing system. Each distributed computing component may include an associated optical communication device that enables optical communication at a package level. For example, the fault detection system 160 may query optical transceivers, optical engines, and photonic integrated circuits to retrieve optical power readings, per-lane measurements, per-wavelength measurements, temperature measurements, error statistics, laser health data, or optical path state data from the optical interconnects. In some implementations, the operations of operation 902 may be performed using components of computing system 600 described in relation to FIG. 6. For example, processors 610a-610n may execute program instructions 670 stored in system memory 620 to query optical transceivers and optical engines for optical measurements. Network interface 640 may facilitate communication between fault detection system 160 and the plurality of optical interconnects to receive the optical telemetry data. I/O interface 650 may coordinate the data traffic between the optical interconnects and system memory 620, where the received optical measurements may be stored as data 680 for subsequent processing.

Fault detection system 160 may provide a way to collect operational data about how the distributed computing components are functioning. Process 900 then proceeds to an operation 904, where fault detection system 160 receives performance metrics of the distributed computing components. The performance metrics may include one or more of workload activity, synchronization behavior, or thermal conditions associated with the distributed computing components. For example, fault detection system 160 may gather data indicating processor utilization levels, memory bandwidth consumption, timing coordination between components, and temperature readings from sensors on each distributed computing component. In some implementations, the operations of operation 904 may be performed using components of computing system 600 described in relation to FIG. 6. For example, processors 610a-610n may execute program instructions 670 stored in system memory 620 to query the distributed computing components for performance metrics. Network interface 640 may facilitate communication between fault detection system 160 and the distributed computing components to receive workload activity data, synchronization behavior data, and thermal condition data. I/O interface 650 may coordinate the data traffic between the distributed computing components and system memory 620, where the received performance metrics may be stored as data 680 for subsequent correlation with the optical measurements.

Fault detection system 160 may provide a way to use machine learning to identify problems in the computing environment. Following the collection of optical measurements and performance metrics, process 900 moves to operation 906, where fault detection system 160 inputs the optical measurements and the performance metrics into an artificial intelligence model. The artificial intelligence model may be trained to predict potential faults based on the received optical measurements and the received performance metrics. For example, fault detection system 160 may format the collected optical telemetry and component operational data as input vectors and provide the input vectors to a neural network that has learned patterns associated with component failures from historical data.

In some implementations, the operations of operation 906 may be performed using components of computing system 600 described in relation to FIG. 6 and machine learning architectures described in relation to FIG. 7 and FIG. 8. For example, processors 610a-610n may execute program instructions 670 stored in system memory 620 to format the optical measurements and performance metrics as input 704 for machine learning model 702 illustrated in FIG. 7. The machine learning model 702 may process the input 704 including the optical telemetry and component operational data to generate output 706 indicating potential faults within the distributed computing system. Output 706 may include fault predictions, confidence intervals, or other metrics indicating the certainty of the detected faults. The output parameters of output 706 may be fed back to machine learning model 702 as input to train the machine learning model, enabling the model to update its configurations based on the assessment of its predictions and reference feedback information such as confirmed fault events or maintenance records.

In some implementations, the artificial intelligence model used in operation 906 may include a transformer architecture as described in relation to FIG. 8. Transformer 812 may include an encoder 808 and a decoder 810 that process the optical measurements and performance metrics to detect potential faults. The optical measurements and performance metrics may be tokenized and converted into embeddings 806 using embedding matrix 804. Encoder 808 may encode embeddings 806 into feature vectors 814 that represent latent features of the optical telemetry and component operational data. Feature vectors 814 may capture relationships between optical power degradation patterns, error statistics, workload activity levels, and thermal conditions across the distributed computing system. Decoder 810 may map feature vectors 814 into output tokens 816 that represent fault classifications, fault domain identifications, or severity assessments. The self-attention mechanisms within transformer 812 may enable the artificial intelligence model to identify correlations between optical measurements from different optical interconnects and performance metrics from different distributed computing components, facilitating detection of faults that manifest across multiple components or optical paths within the distributed computing system.

Fault detection system 160 may provide a way to pinpoint where a problem is occurring within the computing architecture. Process 900 then continues to an operation 908, where fault detection system 160 determines a fault domain within the distributed computing system based on the output of the artificial intelligence model. The fault domain may include one or more of a chiplet interface, an optical engine, a laser source, a coupler, or a reconfigurable optical path. For example, when the artificial intelligence model detects anomalous patterns in the optical measurements and the performance metrics, fault detection system 160 may identify that the issue originates from a degraded laser source within a co-packaged optical assembly or from a misaligned coupler at a package boundary.

In some implementations, the operations of operation 908 may be performed using components of computing system 600 described in relation to FIG. 6. For example, processors 610a-610n may execute program instructions 670 stored in system memory 620 to analyze the output of the artificial intelligence model and determine the fault domain within the distributed computing system. System memory 620 may store data 680 including topology information that maps optical measurements to specific optical interconnect components such as chiplet interfaces, optical engines, laser sources, couplers, and reconfigurable optical paths. Processors 610a-610n may query the topology information stored in data 680 to correlate the detected anomalous patterns with physical locations and component identifiers within the distributed computing system. I/O interface 650 may coordinate data retrieval from system memory 620 to enable processors 610a-610n to access historical fault records and component configuration data that assist in narrowing the fault domain to specific components or optical paths. Network interface 640 may facilitate communication with external databases or management systems that maintain component inventory and maintenance history information relevant to fault domain determination.

Fault detection system 160 may provide a way to communicate detected issues and take action. Process 900 then moves to operation 910, where fault detection system 160 generates a message including a repair recommendation, an alert, or an automated corrective action based on the determined fault domain. The automated corrective action may include rerouting traffic, lowering link rate, retuning photonic elements, or scheduling maintenance. For example, fault detection system 160 may send a notification to maintenance personnel recommending replacement of a degraded laser source, or fault detection system 160 may automatically instruct optical circuit switches to redirect traffic from a degraded optical path to an alternate optical path with acceptable optical health metrics.

In some implementations, the operations of operation 910 may be performed using components of computing system 600 described in relation to FIG. 6. For example, processors 610a-610n may execute program instructions 670 stored in system memory 620 to generate the message based on the determined fault domain. System memory 620 may store data 680 including remediation databases that associate fault classifications with corresponding repair recommendations, alert templates, and automated corrective action procedures. Processors 610a-610n may query the remediation databases stored in data 680 to retrieve the appropriate response for the identified fault domain. Network interface 640 may transmit the generated message to maintenance personnel, management systems, or network devices such as optical circuit switches that execute automated corrective actions. I/O interface 650 may coordinate communication between processors 610a-610n and I/O devices 660 to display alerts on monitoring consoles or to interface with external systems that manage maintenance scheduling and component inventory. Network interface 640 may also facilitate communication with optical circuit switches to transmit control signals that reroute traffic or adjust link parameters in response to detected faults.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

A number of implementations have been described. Nevertheless, it will be understood that various modifications may be made without departing from the spirit and scope of the disclosure. Accordingly, other implementations are within the scope of the following claims.

A1. A method comprising: receiving optical measurements from a plurality of optical interconnects internal to a distributed computing system, wherein the plurality of optical interconnects couples distributed computing components of the distributed computing system, and wherein each distributed computing component includes an associated optical communication device that enables optical communication at a package level; receiving performance metrics of the distributed computing components comprising one or more of workload activity, synchronization behavior, or thermal conditions associated with the distributed computing components; inputting the optical measurements from the plurality of optical interconnects and the performance metrics of the distributed computing components into an artificial intelligence model to detect potential faults within the distributed computing system, wherein the artificial intelligence model has been trained to predict the potential faults based on received optical measurements and received performance metrics; determining, based on one or more potential faults, a fault domain within the distributed computing system, wherein the fault domain comprises one or more of a chiplet interface, an optical engine, a laser source, a coupler, or a reconfigurable optical path; and generating, based on the fault domain, a message comprising a repair recommendation, an alert, or an automated corrective action.

A2. The method of embodiment A1, wherein the optical measurements comprise one or more of optical power measurements, per-lane measurements, per-wavelength measurements, temperature measurements, error statistics, laser health data, or optical path state data.

A3. The method of any of embodiments A1-A2, further comprising: determining a plurality of optical paths associated with the distributed computing components, wherein each optical path of the plurality of optical paths is associated with two or more distributed computing components; generating a plurality of path tags within the optical measurements to indicate a corresponding optical path for each measurement of the optical measurements; and adding the plurality of path tags to the optical measurements prior to inputting the optical measurements into the artificial intelligence model.

A4. The method of any of embodiments of A1-A3, further comprising: determining for the plurality of optical paths a corresponding set of components that communicate over each optical path of the plurality of optical paths; generating a plurality of component tags within the optical measurements to indicate the corresponding set of components for each optical path of the plurality of optical paths; and adding the plurality of component tags to the optical measurements prior to inputting the optical measurements into the artificial intelligence model.

A5. The method of any of embodiments A1-A4, wherein the automated corrective action comprises one or more of retuning photonic elements within the distributed computing system and rerouting traffic within the distributed computing system over a different path.

A6. The method of any of embodiments A1-A5, wherein the plurality of optical interconnects comprises a unified monitored fabric spanning the distributed computing system, the unified monitored fabric providing visibility into optical paths between the distributed computing components that would not be visible to network-level monitoring of links between separate network devices.

A7. The method of any of embodiments A1-A6, further comprising: identifying, for each optical measurement of the optical measurements a corresponding associated optical path; determining, for each corresponding optical path, a set of distributed computing system components associated with each optical path; determining, based on corresponding directions of communication, a correlation between each optical measurement of the optical measurements and one or more corresponding performance metrics with the received performance metrics; and linking the optical measurements with the one or more corresponding performance metrics prior to inputting into the artificial intelligence model.

A8. The method of any of embodiments A1-A7, wherein the artificial intelligence model identifies degradation patterns associated with specific workload types determined from a combination of the optical measurements and the performance metrics.

A9. The method of any of embodiments A1-A8, wherein the artificial intelligence model is trained using historical optical measurements correlated with observed fault events, corresponding fault domains, and component-level operational performance metrics collected at corresponding optical interconnects of distributed computing systems, and wherein the corresponding optical interconnects comprise one or more of in-rack optical links, board-level optical engines, co-packaged optics, optical chiplets, package-level couplers, or optical switching paths.

A10. The method of any of embodiments A1-A9, further comprising normalizing and correlating the optical measurements with component-level operational performance metrics comprising one or more of the workload activity of each distributed computing component, the synchronization behavior between the distributed computing components, or the thermal conditions of the distributed computing components.

1. A system for monitoring optical computing components, the system comprising:
one or more processors; and
one or more non-transitory computer-readable media comprising instructions that, when executed by the one or more processors, cause the one or more processors to perform operations comprising:
receiving optical measurements from a plurality of optical interconnects internal to a distributed computing system, wherein the plurality of optical interconnects couples distributed computing components of the distributed computing system, and wherein the plurality of optical interconnects includes optical paths at two or more hierarchy levels selected from in-rack optical links, board-level optical engines, co-packaged optics, optical chiplets, package-level couplers, and optical switching paths;
receiving performance metrics of the distributed computing components comprising one or more of workload activity, synchronization behavior, or thermal conditions associated with the distributed computing components;
generating, for each optical measurement, a corresponding tagged telemetry record comprising a corresponding optical measurement obtained from a corresponding optical path, a path identifier for the corresponding optical path, one or more component identifiers for one or more components associated with the corresponding optical path, and at least one component operational metric associated with a communication direction over the corresponding optical path to generate a telemetry dataset;
inputting the telemetry dataset into an artificial intelligence model to detect potential faults within the distributed computing system, wherein the artificial intelligence model has been trained to predict the potential faults based on received telemetry datasets;
determining, based on one or more potential faults, a fault domain within the distributed computing system, wherein the fault domain comprises one or more of a chiplet interface, an optical engine, a laser source, a coupler, or a reconfigurable optical path; and
generating, based on the fault domain, a message comprising a repair recommendation, an alert, or an automated corrective action.

2. The system of claim 1, wherein the optical measurements comprise one or more of optical power measurements, per-lane measurements, per-wavelength measurements, temperature measurements, error statistics, laser health data, or optical path state data.

3. The system of claim 1, wherein the instructions further cause the one or more processors to perform operations comprising:
determining a plurality of optical paths associated with the distributed computing components, wherein each optical path of the plurality of optical paths is associated with two or more distributed computing components;
generating a plurality of path tags within the optical measurements to indicate the corresponding optical path for each measurement of the optical measurements; and
adding the plurality of path tags to the optical measurements prior to inputting the optical measurements into the artificial intelligence model.

4. The system of claim 3, wherein the instructions further cause the one or more processors to perform operations comprising:
determining for the plurality of optical paths a corresponding set of components that communicate over each optical path of the plurality of optical paths;
generating a plurality of component tags within the optical measurements to indicate the corresponding set of components for each optical path of the plurality of optical paths; and
adding the plurality of component tags to the optical measurements prior to inputting the optical measurements into the artificial intelligence model.

5. The system of claim 1, wherein the automated corrective action comprises one or more of retuning photonic elements within the distributed computing system and rerouting traffic within the distributed computing system over a different path.

6. The system of claim 1, wherein the plurality of optical interconnects comprises a unified monitored fabric spanning the distributed computing system, the unified monitored fabric providing visibility into optical paths between the distributed computing components that would not be visible to network-level monitoring of links between separate network devices.

7. The system of claim 1, wherein the instructions further cause the one or more processors to perform operations comprising:
identifying, for each optical measurement of the optical measurements a corresponding associated optical path;
determining, for each corresponding optical path, a set of distributed computing system components associated with each optical path;
determining, based on corresponding directions of communication, a correlation between each optical measurement of the optical measurements and one or more corresponding performance metrics within received performance metrics; and
linking the optical measurements with the one or more corresponding performance metrics prior to inputting into the artificial intelligence model.

8. The system of claim 1, wherein the artificial intelligence model identifies degradation patterns associated with specific workload types determined from a combination of the optical measurements and the performance metrics.

9. The system of claim 1, wherein the artificial intelligence model is trained using historical optical measurements correlated with observed fault events, corresponding fault domains, and component-level operational performance metrics collected at corresponding optical interconnects of distributed computing systems, and wherein the corresponding optical interconnects comprise one or more of in-rack optical links, board-level optical engines, co-packaged optics, optical chiplets, package-level couplers, or optical switching paths.

10. The system of claim 1, wherein the instructions further cause the one or more processors to normalize and correlate the optical measurements with component-level operational performance metrics comprising one or more of the workload activity of each distributed computing component, the synchronization behavior between the distributed computing components, or the thermal conditions of the distributed computing components.

11. A method comprising:
receiving optical measurements from a plurality of optical interconnects internal to a distributed computing system, wherein the plurality of optical interconnects couples distributed computing components of the distributed computing system, wherein the plurality of optical interconnects includes optical paths at two or more hierarchy levels selected from in-rack optical links, board-level optical engines, co-packaged optics, optical chiplets, package-level couplers, and optical switching paths;
receiving performance metrics of the distributed computing components;
generating, for each optical measurement, a corresponding tagged telemetry record comprising a corresponding optical measurement obtained from a corresponding optical path, a path identifier for the corresponding optical path, one or more component identifiers for one or more components associated with the corresponding optical path, and at least one component operational metric associated with a communication direction over the corresponding optical path to generate a telemetry dataset;
inputting the telemetry dataset into an artificial intelligence model to detect potential faults within the distributed computing system, wherein the artificial intelligence model has been trained to predict the potential faults based on received telemetry datasets;
determining, based on one or more potential faults, a fault domain within the distributed computing system; and
generating, based on the fault domain, a message comprising a repair recommendation, an alert, or an automated corrective action.

12. The method of claim 11, wherein the optical measurements comprise one or more of optical power measurements, per-lane measurements, per-wavelength measurements, temperature measurements, error statistics, laser health data, or optical path state data.

13. The method of claim 11, further comprising:
determining a plurality of optical paths associated with the distributed computing components, wherein each optical path of the plurality of optical paths is associated with two or more distributed computing components;
generating a plurality of path tags within the optical measurements to indicate a corresponding optical path for each measurement of the optical measurements; and
adding the plurality of path tags to the optical measurements prior to inputting the optical measurements into the artificial intelligence model.

14. The method of claim 13, wherein further comprising:
determining for the plurality of optical paths a corresponding set of components that communicate over each optical path of the plurality of optical paths;
generating a plurality of component tags within the optical measurements to indicate the corresponding set of components for each optical path of the plurality of optical paths; and
adding the plurality of component tags to the optical measurements prior to inputting the optical measurements into the artificial intelligence model.

15. The method of claim 11, wherein the automated corrective action comprises one or more of retuning photonic elements within the distributed computing system and rerouting traffic within the distributed computing system over a different path.

16. One or more non-transitory, computer-readable media storing instructions thereon that when executed by one or more processors cause the one or more processors to perform operations comprising:
receiving optical measurements from a plurality of optical interconnects internal to a distributed computing system, wherein the plurality of optical interconnects couples distributed computing components of the distributed computing system;
receiving performance metrics of the distributed computing components;
inputting the optical measurements from the plurality of optical interconnects and the performance metrics of the distributed computing components into an artificial intelligence model to detect potential faults within the distributed computing system, wherein the artificial intelligence model has been trained to predict the potential faults based on received optical measurements and received performance metrics;
determining, based on one or more potential faults, a fault domain within the distributed computing system, wherein the fault domain; and
generating, based on the fault domain, a message comprising a repair recommendation, an alert, or an automated corrective action.

17. The one or more non-transitory, computer-readable media of claim 16, wherein the optical measurements comprise one or more of optical power measurements, per-lane measurements, per-wavelength measurements, temperature measurements, error statistics, laser health data, or optical path state data.

18. The one or more non-transitory, computer-readable media of claim 16, wherein the instructions further cause the one or more processors to perform operations comprising:
determining a plurality of optical paths associated with the distributed computing components, wherein each optical path of the plurality of optical paths is associated with two or more distributed computing components;
generating a plurality of path tags within the optical measurements to indicate a corresponding optical path for each measurement of the optical measurements; and
adding the plurality of path tags to the optical measurements prior to inputting the optical measurements into the artificial intelligence model.

19. The one or more non-transitory, computer-readable media of claim 18, wherein the instructions further cause the one or more processors to perform operations comprising:
determining for the plurality of optical paths a corresponding set of components that communicate over each optical path of the plurality of optical paths;
generating a plurality of component tags within the optical measurements to indicate the corresponding set of components for each optical path of the plurality of optical paths; and
adding the plurality of component tags to the optical measurements prior to inputting the optical measurements into the artificial intelligence model.

20. The one or more non-transitory, computer-readable media of claim 16, wherein the automated corrective action comprises one or more of retuning photonic elements within the distributed computing system and rerouting traffic within the distributed computing system over a different path.
